(19) United States
(12) Patent Application Publication
(10) Pub. No.: US 2010/0042451 A1
(43) Pub. Date: Feb. 18, 2010

(54) Risk management decision facilitator

(76) Inventor: Gary L. Howell, Woodinville, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/228,541

(22) Filed: Aug. 12, 2008

(51) Int. Cl. G06Q 10/00; G06N 5/02; G06F 11/07

(52) U.S. Cl. 705/7; 706/52; 714/2; 714/49; 714/E11.023; 714/E11.024

(57) ABSTRACT

Methods and systems for facilitating risk management decisions are provided. Example embodiments provide a Risk Management Decision Facilitator System “RMDFS”, which enables users to normalize all risk management decisions so that they are made consistently, in-line with entity policy, regardless of who is making them and their point in a product lifecycle. An example RMDFS accomplish these goals by providing components and processes that are linked together using a normalized risk matrix, so that all decisions are viewed against a standardized set of severity terms, likelihood terms, and risk classifications regardless of the particulars of the product or process being manipulated. All problem assessments, risk assessments, and risk controls are automatically evaluated quantitatively and qualitatively. This abstract is provided to comply with rules requiring an abstract, and it is submitted with the intention that it will not be used to interpret or limit the scope or meaning of the claims.

### TECHNICAL FIELD

The present disclosure relates to methods, systems, and techniques for facilitating risk management and, in particular, to methods and systems for facilitating consistent decision making regarding handling of risks that a device and/or product will cause harm.

### BACKGROUND

Managing risk that a severe harm may occur as a result of using a device or product or providing service for one is often a grave concern to companies that manufacture, sell, service, and/or distribute devices or products that may cause injury or even death, even in their normal use. Such companies are often faced with tradeoffs regarding the cost and/or difficulty of anticipating and preventing such harm against the benefits made available from use of such products. In the medical device world, for example, this is sometimes a more difficult tradeoff, because the benefits are often live-saving, but the potential harms fatal. Some amount of risk in such situations may be ultimately worth having the device available and financially accessible to customers in need. Decisions such as “how much risk is tolerable” and “what procedures, tests, etc. need to be instituted and at what cost to the end product” are examples of some of the risk management decisions that need to be made during the course of designing, manufacturing, distributing, and servicing such products.

In sum, risk management decisions are important to ensure that devices and/or products meet industry standards when they exist, meet customer expectations, and are consistent with the risk management philosophies of the company providing the device and/or product. Because typically many different people, of different experience levels, training, and responsibility are involved in product design, production, and distribution, and because typically many different subcomponents and/or processes are used, it can be challenging to ensure that decisions throughout a company are consistent—even when they involve just one product, let alone multiple products. Often each group within the company manages risk independently of other groups in the company. Moreover, that certain harms may be acceptable in some situations but not others further complicates risk management analyses.

Some risk management standards have been developed and published to address risk management in particular industries, such as the ISO 14971 standard, to encourage companies responsible for medical devices to provide devices that manage risk to a level “as low as reasonably practicable” (“ALARP”) bearing in mind the benefits derived from the device. However, little absolute qualitative or quantitative measurements are associated with these guidelines. In addition, the human judgments required to assess what ALARP means for a particular product or device may be inconsistent across the people/departments responsible for producing, distributing, and/or servicing the device. For any given medical device and situation where it is used, the ISO 14971 standard recognizes that there is a broadly acceptable region of a risk, so low that it is negligible compared to the other risks and benefit achieved; an ALARP region of risk, which recognizes that the risk is “as low as reasonably practicable;” and an intolerable region, in which the risk is not tolerated, regardless of the benefit. However, the ISO 14971 standard provides little guidance to a manufacturer to figure out which decisions cause a particular risk to fall within one category over another consistently, across the design process to manufacturing, and further to distribution and to customer use, and how particular adjustments may mitigate a risk in a quantitative and qualitative fashion.

Moreover, in the manufacture of other types of devices and products, risk management standards have yet to be articulated or established.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is an example block diagram of an overview of an example risk management lifecycle process aided by an example Risk Management Decision Facilitator System.

FIG. 2 is an example block diagram of components of an example Risk Management Decision Facilitator System.

FIG. 3 is an example screen display for setting up entity-wide high level risk management philosophies in an example Risk Management Decision Facilitator System.

FIG. 4 is an example block diagram illustrating generation of one or more risk management matrices.

FIGS. 5A-5C are example screen displays for indicating entity-wide term and value definitions for the applicable risk management matrix.

FIG. 6 is an example block diagram illustrating an example risk Management matrix that maps example entity-wide definitions to a standard risk management matrix.

FIGS. 7A-7C are example screen displays for indicating product-specific risk management terms and value variances within an entity-wide risk management structure.

FIGS. 8A-8H are example screen displays for indicating hazard, harm, and risk control related parameters for use in defining hazard scenarios in an example Risk Management Decision Facilitator System.

FIGS. 9A-9D are example screen displays for indicating component part related parameters for use in analyzing and assessing risk related to inherent failures of subcomponents of a product in an example Risk Management Decision Facilitator System.

FIGS. 10A-10C are example screen displays for indicating process related parameters for use in defining risk controls for and assessing risk related to process induced failures of a product in an example Risk Management Decision Facilitator System.

FIG. 11 is an example screen display, in an example Risk Management Decision Facilitator System, for indicating the types of reports to be used to identify and characterize demonstrated risk experience in using a product.

FIGS. 12A-12D are example screen displays for defining relationships between sub-assemblies and between processes used in the lifecycle of a product.

FIGS. 13A-13B are example screen displays for assigning user level or group level risk management responsibility on a per product basis.

FIGS. 14A-14E are example screen displays illustrating data entry for an example hazard scenario in an example Risk Management Decision Facilitator System.

FIGS. 15A-15B are example screen displays illustrating data entry for inherent failures relating to the example hazard scenario defined in FIGS. 13A-13E.

FIGS. 16A-16C are example screen displays illustrating data entry for process related failures linked to the example hazard scenario defined in FIGS. 13A-13E.

FIGS. 17A-17B are example screen displays illustrating data entry for identifying and characterizing demonstrated risk experience as a result of harm from using a product that is linked to the example hazard scenario defined in FIGS. 13A-13E.

FIG. 18 is an example screen display of a report generated for a demonstrated risk experience using an example Risk Management Decision Facilitator System.

FIG. 19 is an example screen display of validation and verification support provided by an example Risk Management Decision Facilitator System.

FIG. 20 is an example block diagram of electronic file management techniques employed by an example Risk Management Decision Facilitator System.

FIG. 21 is an example block diagram of components of an example Risk Management Decision Facilitator System.

### DETAILED DESCRIPTION

Embodiments described herein provide enhanced computer- and network-based methods, techniques, and systems for facilitating risk management decisions by providing one or more tools for entities to use when assessing risk, when defining risk controls, and to track the efficacies of instituted measures. Example embodiments provide a Risk Management Decision Facilitator System (“RMDFS”), which enables users to normalize all risk management decisions so that they are made consistently, as defined and in-line with entity (e.g., company) policy, regardless of who is making them and at which point in a product lifecycle they are being made. Example RMDFSes accomplishes these goals by providing a series of components and processes that are linked together using a normalized risk matrix, so that all decisions are viewed against a standardized set of severity terms, likelihood terms and thresholds, and risk classifications regardless of the particulars of the product or process being manipulated. That way, all problem assessments, risk assessments, and risk controls can be evaluated and compared quantitatively and qualitatively automatically by the RMDFS.

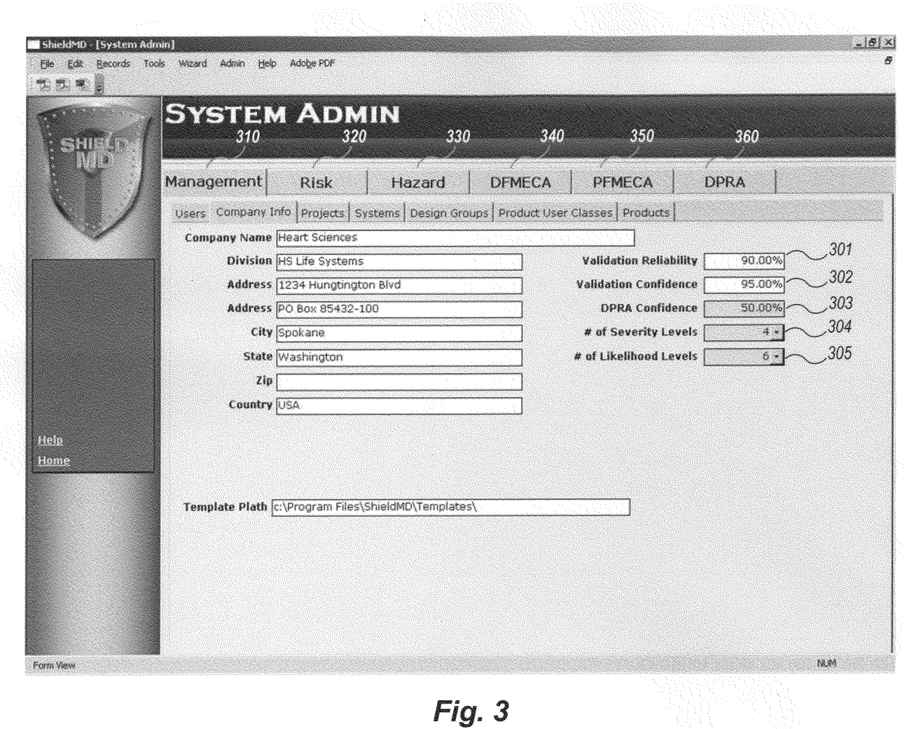

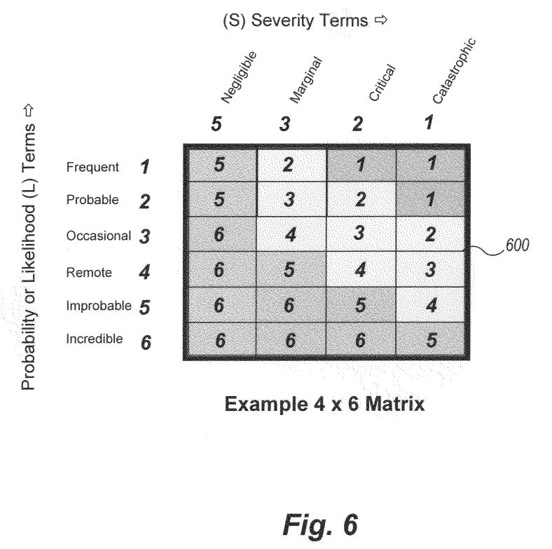

A risk matrix, described further with respect to FIGS. 3 and 6, is a qualitative measure of risk that classifies risk of harm according to a combination of its severity (kind of harm) and likelihood of occurrence. Different risk classifications may be used to determine ultimately whether a risk is acceptable, questionable, or unacceptable. A user can use the RMDFS to associate various quantifications with a risk matrix that are company or product specific in order to attribute measurable value to the different risk classifications. Also, the user can associate various definitions with each risk classification that make sense with the company and/or product model. A risk matrix may be of different sizes in order to represent risk with greater or lesser granularity (precision) and may be implemented by any type of data structure suitable for representing at least a two dimensional structure.

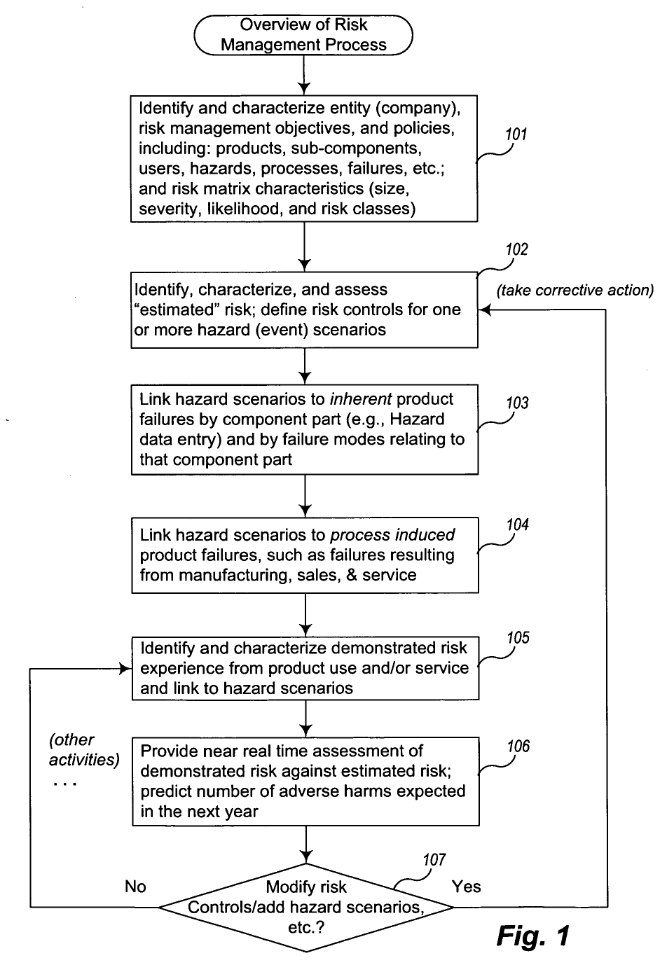

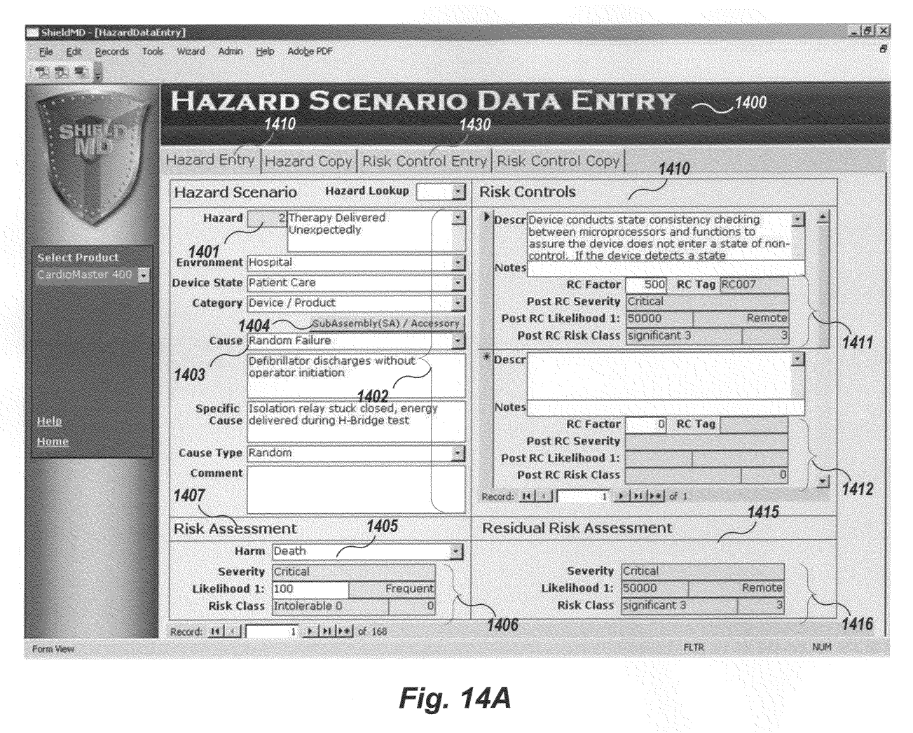

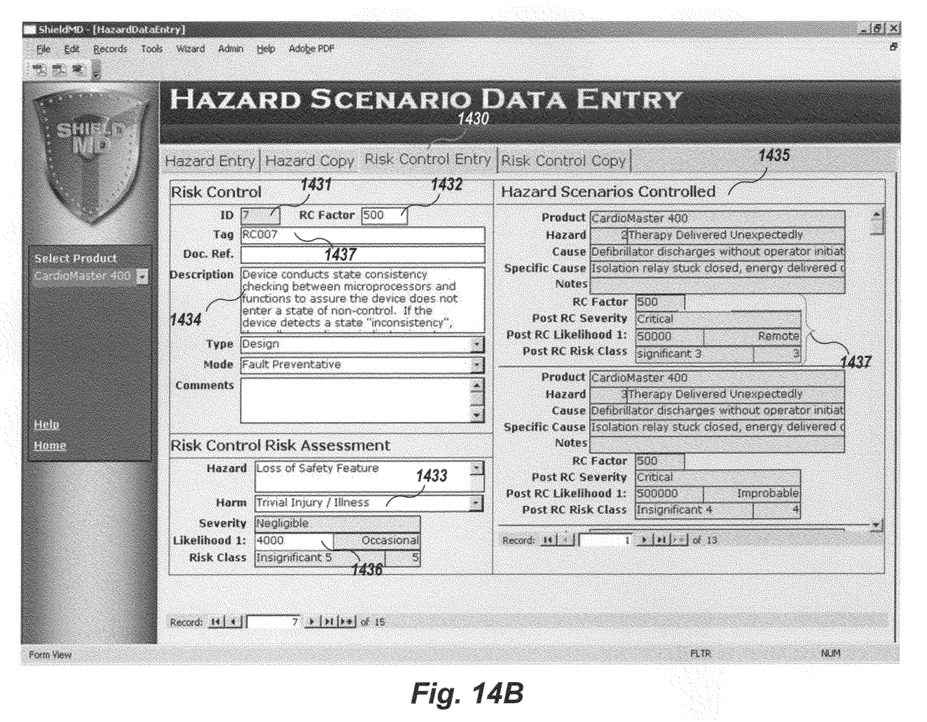

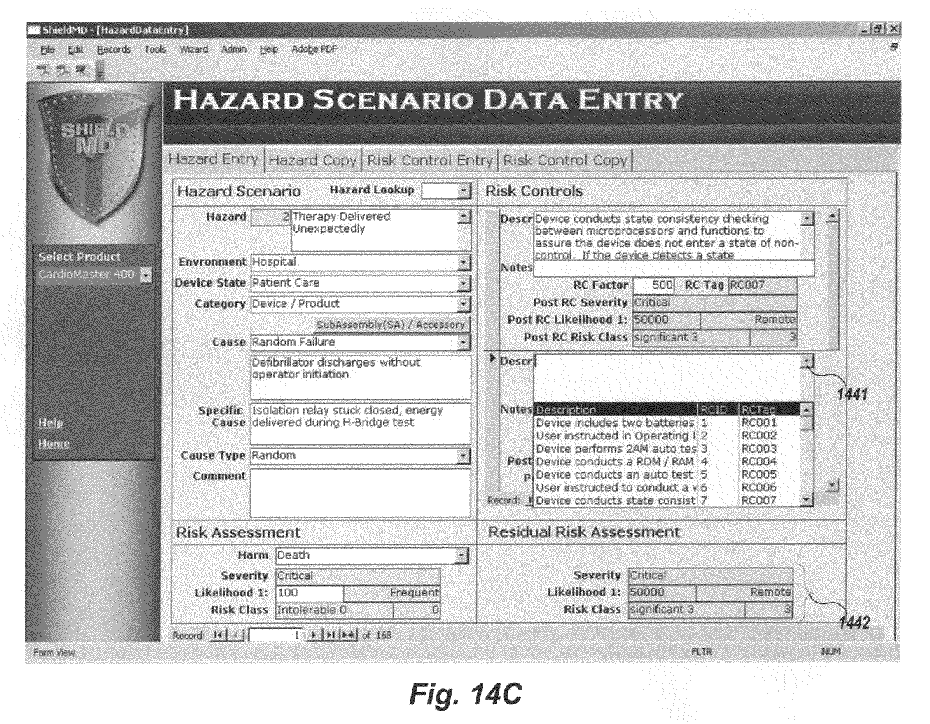

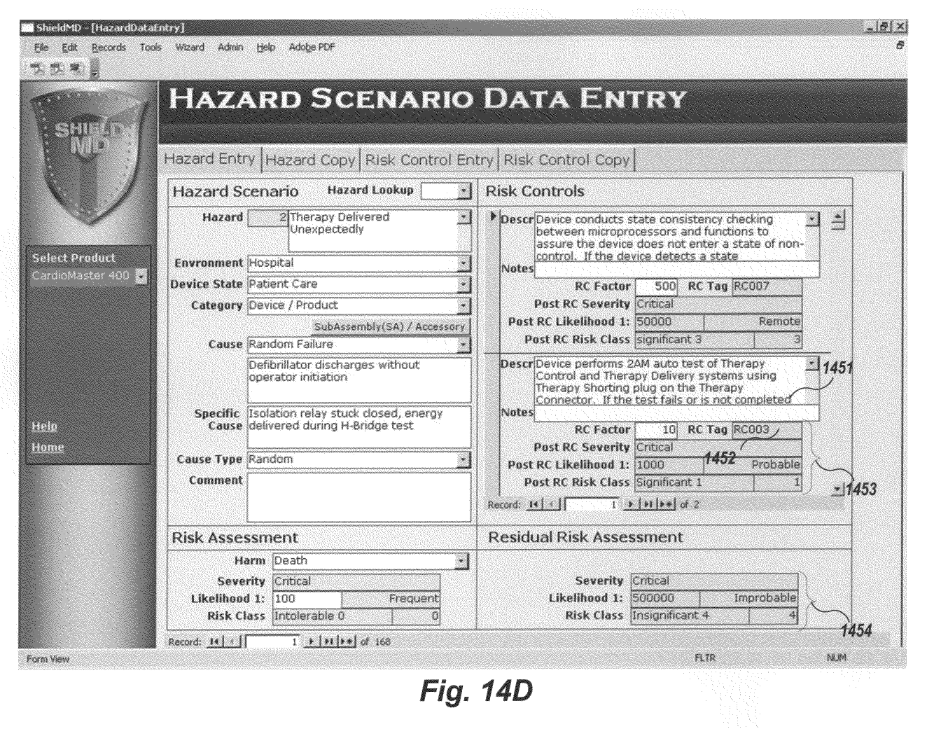

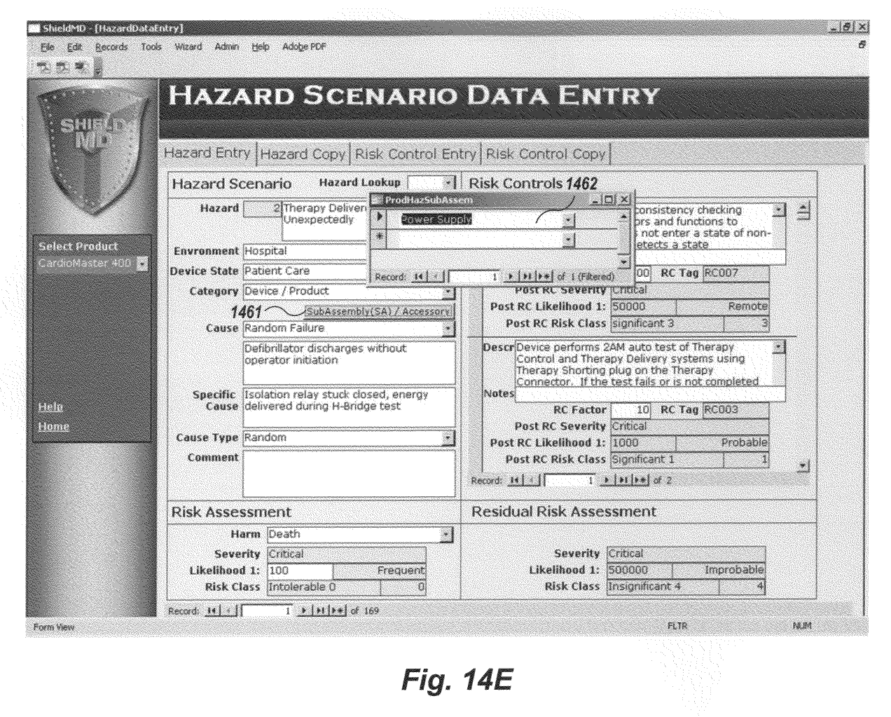

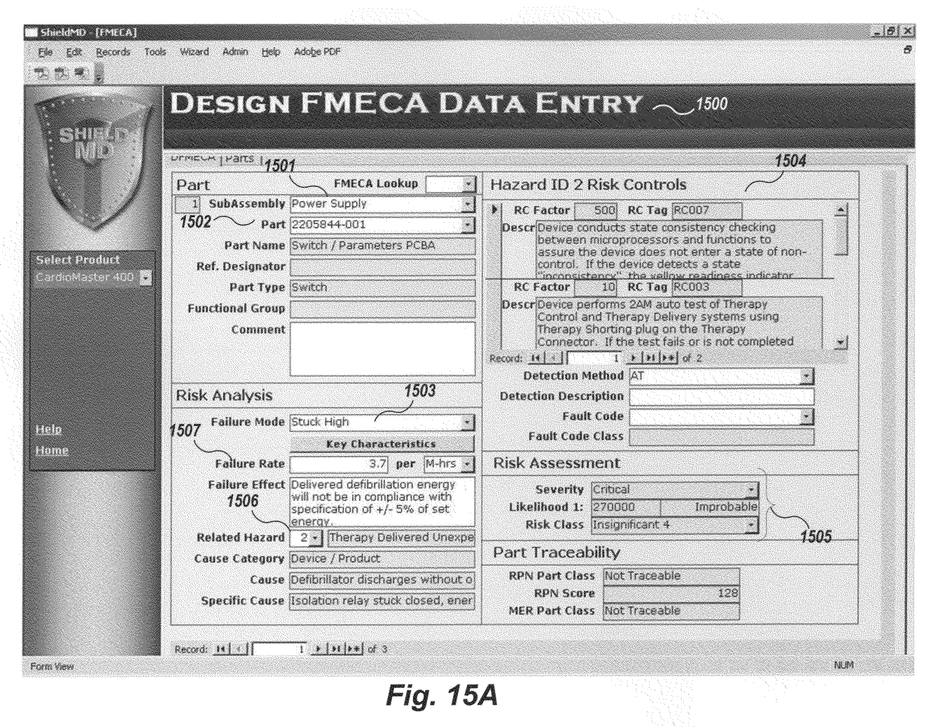

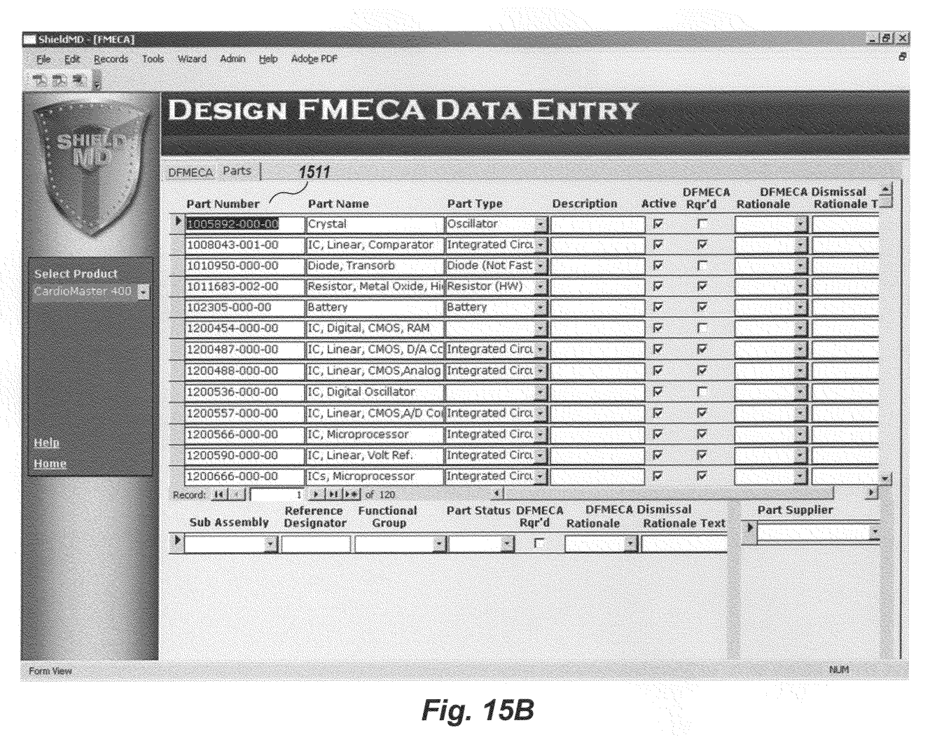

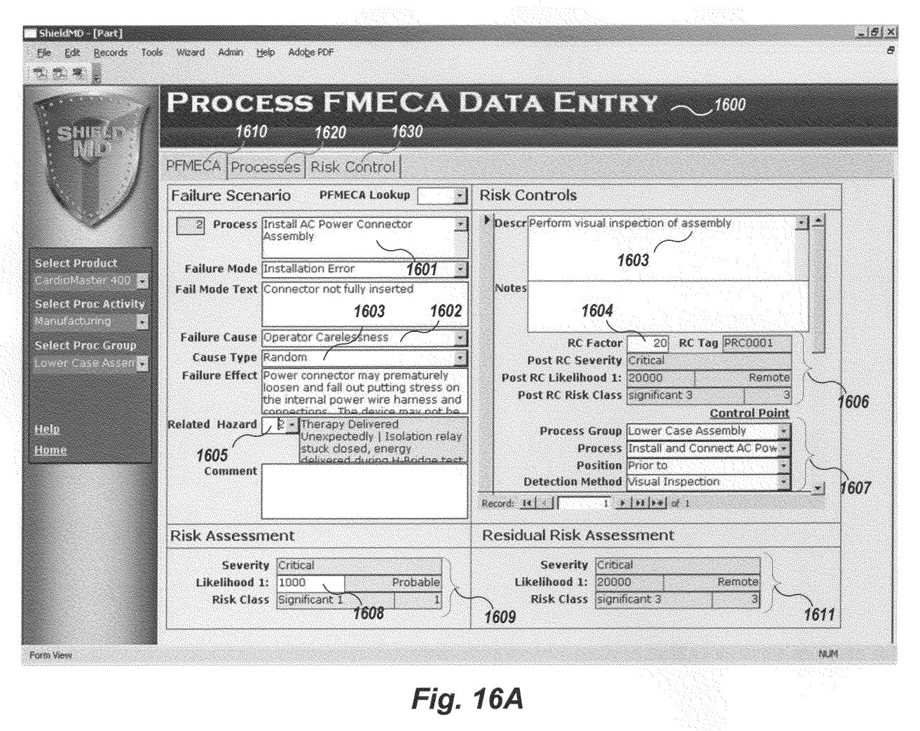

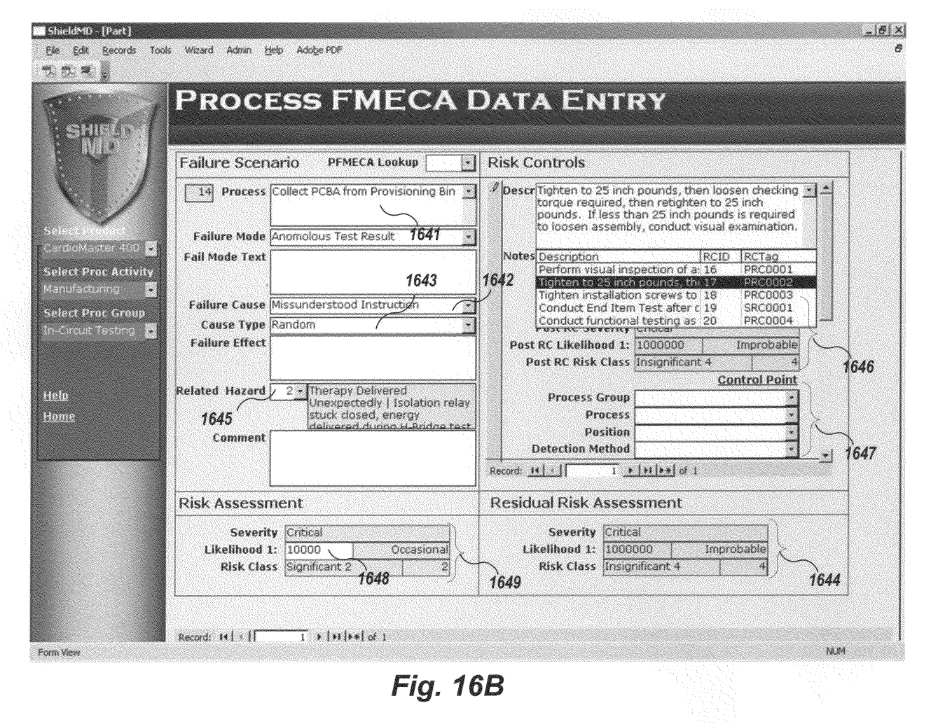

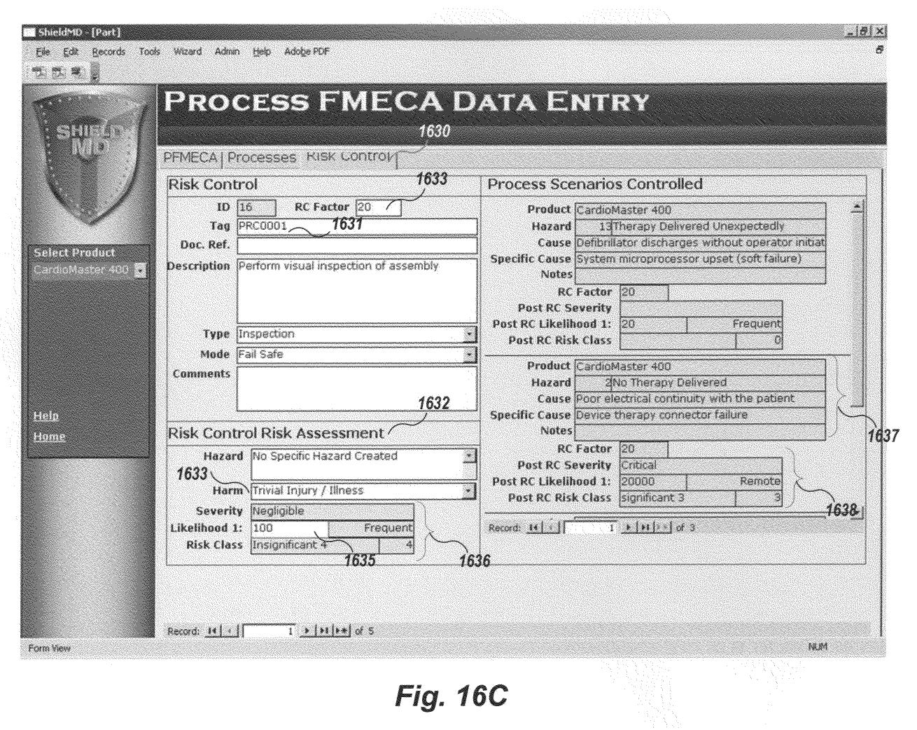

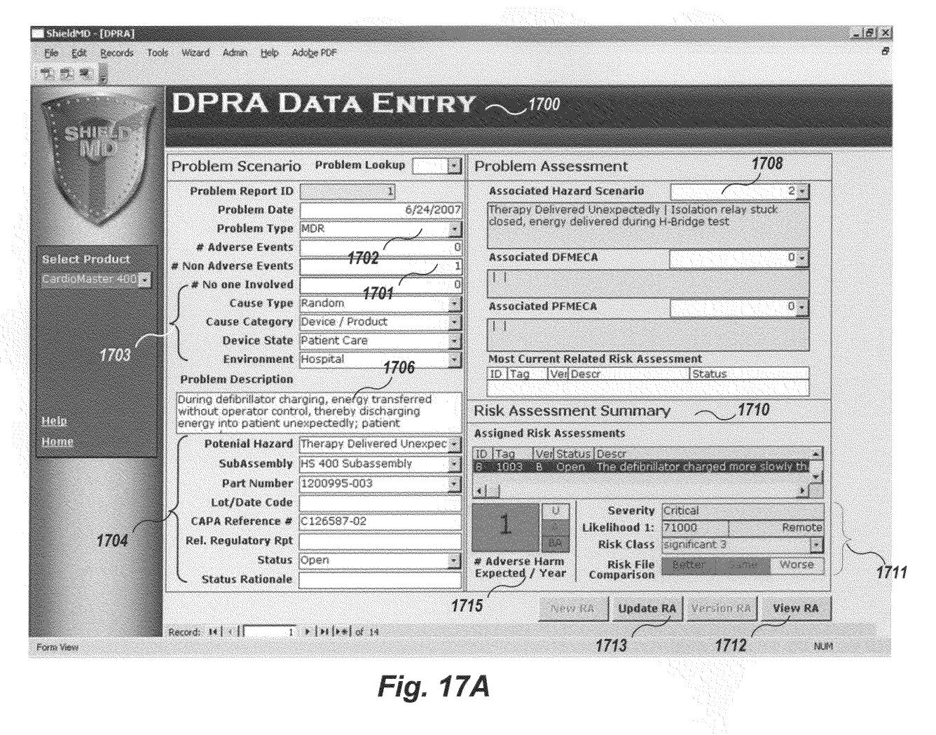

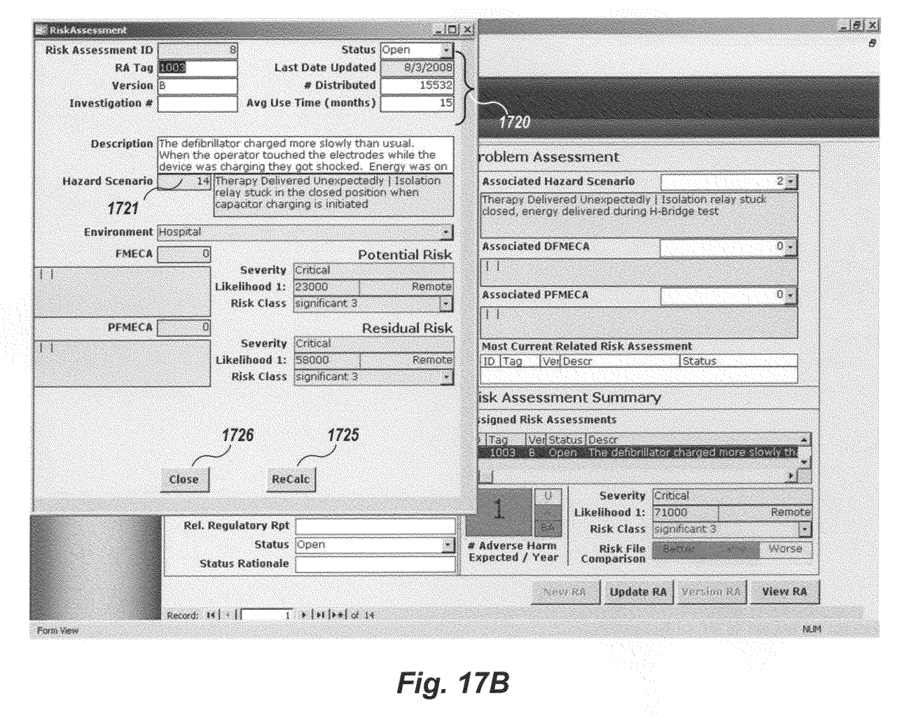

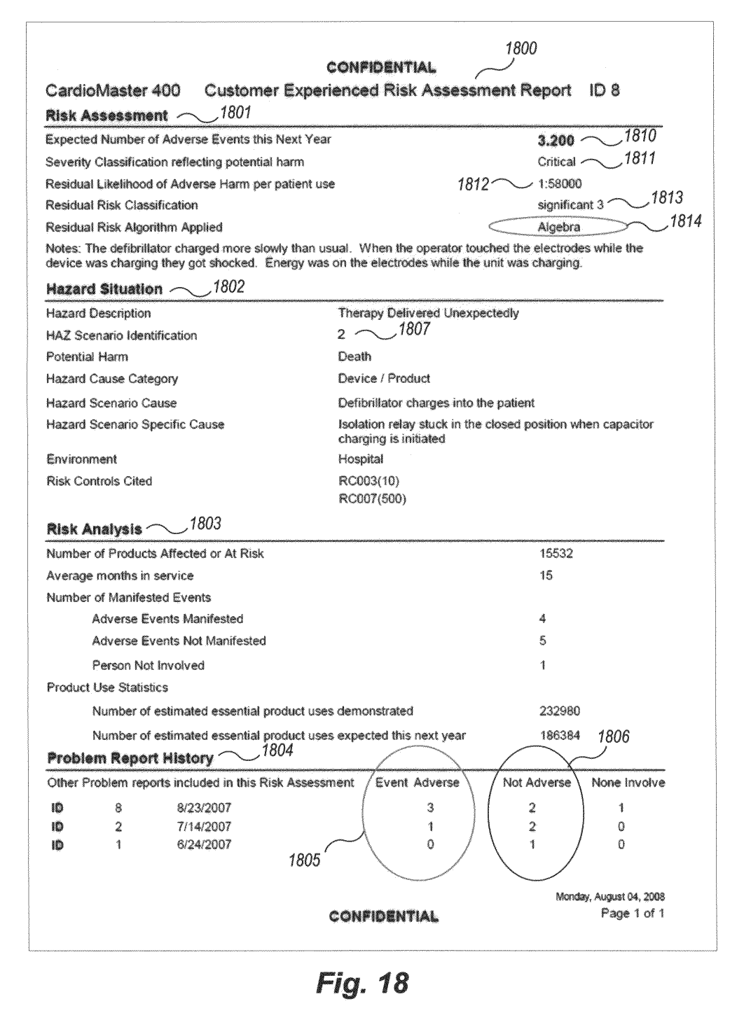

FIG. 1 is an example block diagram of an overview of an example risk management lifecycle process that can be aided by an example Risk Management Decision Facilitator System. First, the company (or other entity wanting to perform risk management decisions) identifies and characterizes (e.g., qualifies and quantifies) its risk management objective and policies (step 101). For example, in this step the company decides the level of precision it wishes to use when characterizing risk, what products will be managed, their sub-assemblies, design and manufacturing processes, possible failures, etc. The company may also set risk management goals pertaining to individual products and may link specific personnel or types of user to be held responsible for risk management decisions. Further details of example steps within this process are described further below with respect to FIGS. 3A-13B. Next, the company defines the type of events that create a risk of harm (hazard scenarios), including assessing their risk and the types of controls that may be instituted to mitigate or alleviate the risk and/or harm (step 102). Further details of example steps within this process are described further below with respect to FIGS. 14A-14E. Then, the company defines and quantifies the types of product failures (such as sub-assembly defects) that could produce the risks of harm detailed in the various hazard scenarios and links each to one or more of the hazard scenarios (step 103). This act allows the system to automatically quantify the effect each of these failures may have upon the hazard scenarios effected. Further details of example steps within this process are described further below with respect to FIGS. 15A-15B. Next, the company defines and quantifies the types of process failures (such as omissions in the manufacturing process) that may contribute to the risks of harm detailed in the various hazard scenarios and links each to one or more hazard scenarios (step 104). This act allows the system to automatically quantify the effect of each process failure upon the hazard scenarios effected. Further details of example steps within this process are described further below with respect to FIGS. 16A-16C. Once steps 101-104 are initially completed, the risk management characterization for a product can be compared against demonstrated use (step 105) to determine whether the risk management controls that were put in place actually resulted (e.g., from examining the demonstrated use) in more risk than estimated, less risk, or the same. In addition, the Risk Management Decision Facilitator System can provide a prediction of the number of adverse harms (as defined by the company, for example death) expected in the next year (step 106) using mathematical methods. Further details of example steps within this process are described further below with respect to FIGS. 17A-18. If actual risk of harm was different than that estimated, or if the prediction of adverse harms yields an undesirable result, then appropriate personnel can decide to modify the risk management model (step 107) and take corrective action by reconfiguring some aspect of the hazard scenarios, failure modeling data, etc. (by returning to step 102, 103, or 104). This process of comparing estimated risk of harm with actual demonstrated data (steps 105-107) and then taking corrective action may be repeated any number of times to facilitate applying better risk controls and managing risk within the parameters desired by the company.

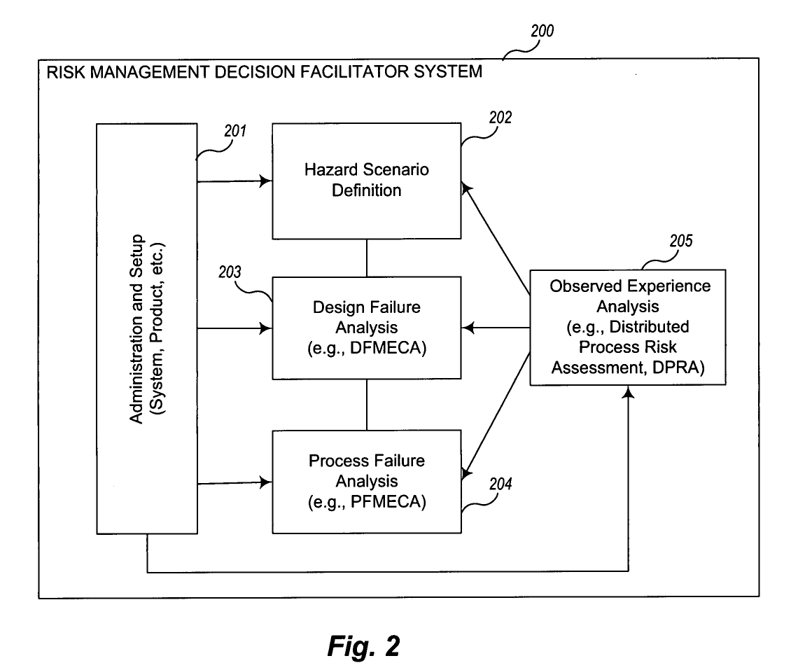

FIG. 2 is an example block diagram of components of an example Risk Management Decision Facilitator System. In one embodiment, the Risk Management Decision Facilitator System comprises one or more functional components/modules that work together to help users manage risk management decisions. These components may be implemented in software or hardware or a combination of both. In FIG. 2, an example Risk Management Decision Facilitator System 200 comprises one or more Administration and Setup components (modules) 201, one or more hazard scenario definition components 202, one or more design failure analysis components (e.g., a Design Failure and Criticality Analysis module “DFMECA”) 203, one or more process failure analysis components (e.g., a Process Failure and Criticality Analysis module “PFMECA”) 204, and one more observed experience analysis components (e.g., Distributed Process Risk Assessment “DPRA”) 205. In typical use, designated users within a company use the administration and setup components 201 to define risk parameters that are acceptable for the company, such as the likelihood of harm that is considered acceptable for each classification of harm, what types of risks the company considers acceptable (for example, in line with ISO 14971 guidelines) descriptions of the different kinds or harms, the kinds of failures that may produce harm, details about the product components and processes that are used in each product etc. These parameter values are then used in a hazard scenario definition component 202 to describe the various hazard scenarios (events) that may result in a harm, and an assessment of the risk of that harm, various risk controls that may be put into place to reduce the harm and/or likelihood, and an assessment of residual risk one controls are put into place. The design failure analysis component (e.g., DFMECA) 203 is used to provide detail regarding the specific aspects of the device/product that may pose risks, for example, descriptions of the possible failures that make occur given the sub-assemblies used to create the device. The process failure mode analysis component (e.g., PFMECA) 204 is used to provide detail regarding the specific aspects of processes, such as manufacturing, sales, or service, that are related to creation and/or use of the device/product. The observed experience analysis component 205 is used to record and analyze data regarding real experiences in using or servicing the device/product, so that adjustments may be made to correct the risk management decisions. Parameter values established using the administration and setup component may provide predetermined values for standardizing input to the other components 202-205.

Although the examples herein are described relative to medical devices, manufacturing companies, etc. it is to be understood that equivalent modules and techniques may be applied to other industries and products, such as health service providers (e.g., hospitals, medical centers, doctors' office, etc), space and aerospace manufacturers and/or operators, military systems, automotive, emergency response applications (e.g., for natural disasters, security, etc.), consumer products (e.g., toys, exercise equipment, etc.), food related products and processes, pharmaceutical manufacturing and processing, etc. In addition, the techniques and tools of a Risk Management Decision Facilitator System may be useful to create a variety of other risk management products, including risk management software tools embedded in other systems and distributed in other forms; billing error and omission tools; auditing tools, etc. For example, a Risk Management Decision Facilitator System used for an audit may allow auditing of electronic records for not just compliance, but to support state-of-the-art trending analysis to other entities and throughout the industry as a whole.

Example embodiments described herein provide applications, tools, data structures and other support to implement a Risk Management Decision Facilitator System to be used for helping users and/or companies manage risk management decisions. Although the term “device” is used primarily in these examples, the term is used generally to imply any type of device, product, and/or service. Also, although the examples refer to companies and their users, the techniques described can be used by other types of entities, and input may be computer driven instead of being made by a human. The concepts and techniques described are applicable to any type of “thing” that benefits from risk management and for any type of entity.

Also, although certain terms are used primarily herein, other terms could be used interchangeably to yield equivalent embodiments and examples. For example, it is well-known that equivalent terms in the risk management field and in the statistics field and in other similar fields could be substituted for some of the terms used herein. In addition, terms may have alternate spellings which may or may not be explicitly mentioned, and all such variations of terms are intended to be included.

In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, difference user interfaces, etc. Thus, the scope of the techniques and/or functions described are not limited by the particular order, selection, or decomposition of steps described with reference to any particular routine or to the particular fields shown in any particular screen display.

As described in FIG. 1, one of the functions of a Risk Management Decision Facilitator System is to allow a company to establish risk management objectives, parameters, etc. by which to manage risk for its products. FIG. 3 is an example screen display for setting up entity-wide high level risk management philosophies in an example Risk Management Decision Facilitator System. The example System Admin module may be implemented by the administration and setup component of a Risk Management Decision Facilitator System shown in FIG. 2. The example System Admin user interface shown in FIG. 3 includes six different setup interfaces: management 310, risk 320, hazard 330, DFMEMA 340, PFMECA 350, and DPRA 360. Each of these interfaces further contain other forms (templates, input windows, etc.) for indicating additional parameters, which can be used to define hazard scenarios and potential failures, as well as to assign responsible parties to the various products, parts, and processes. In the management setup 310, information about users, company info, projects, systems, design groups, product user classes, and products may be specified, although other setups could also be made available.

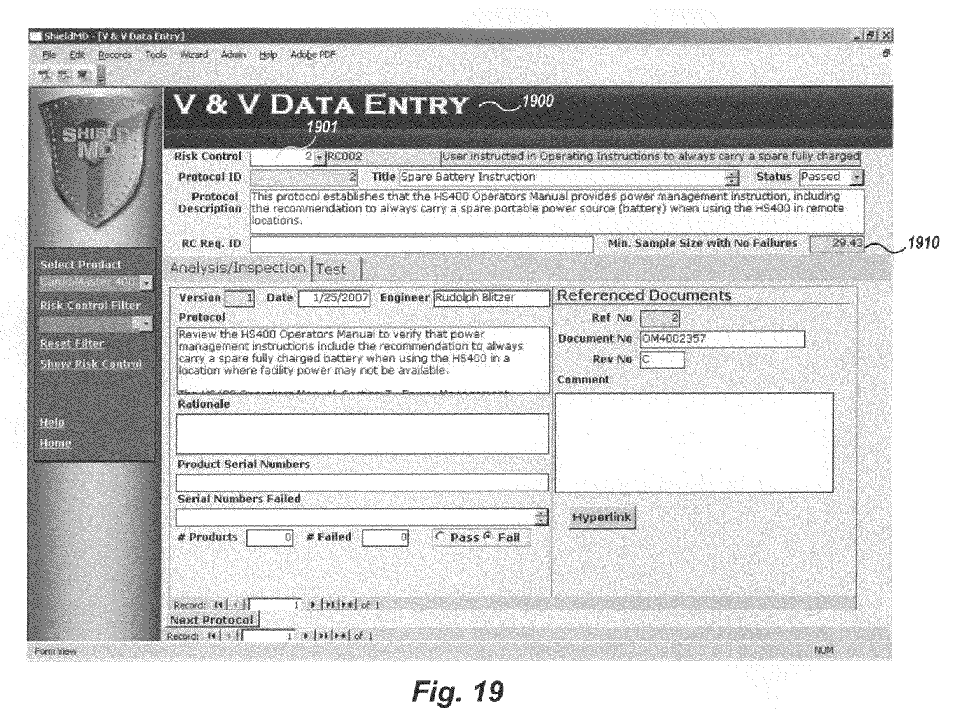

In the form currently displayed in FIG. 3, the company philosophy for validation reliability is set in input field 301. For example, a 90% validation reliability number means that the number of tests to validate risk controls suggested by the RMDFS to be performed (see, e.g., FIG. 19) is predicted to give results that are only 90% reliable. That is, the risk controls will be effective on 90% of the product populations processed, and thus risk control effectiveness is assured 90% of the time, if the number of validation tests suggested are performed. Similarly, the company philosophy for validation confidence is entered in input field 302. For example, a 95% validation confidence means that validation and verification testing as suggested by the RMDFS will yield numbers that assure that risk controls are effective equal to or in excess of company reliability standards 95% of the time. That is, 95% of the time, product risk control effectiveness will reliably (90% of the time) control process errors, omissions, etc. from escaping manufacturer control. The Bayesian model used to determine the number of tests to suggest is: (Reliability=(1−Confidence)^{(1/(n+1))}, where “n” is the sample size.) The confidence in the DPRA estimates (those estimates that indicate the predicted number of adverse harms in the next year) is set in input field 303. This number indicates that the company expects that the prediction should be accurate 50% of the time. The number of severity levels, and number of likelihood levels is set in input fields 304 and 305, respectively. These numbers dictate the precision for risk assessments and, accordingly, the size of the risk matrix that will be used to quantify and qualify risk throughout the products that are managed for that company (using this particular instantiation of the tool). A company that decides to implement different precisions for different products may choose to use multiple instantiations of the tool. (Other embodiments are possible, which use different risk matrices for each product, although at a potential loss of standardization across the company.)

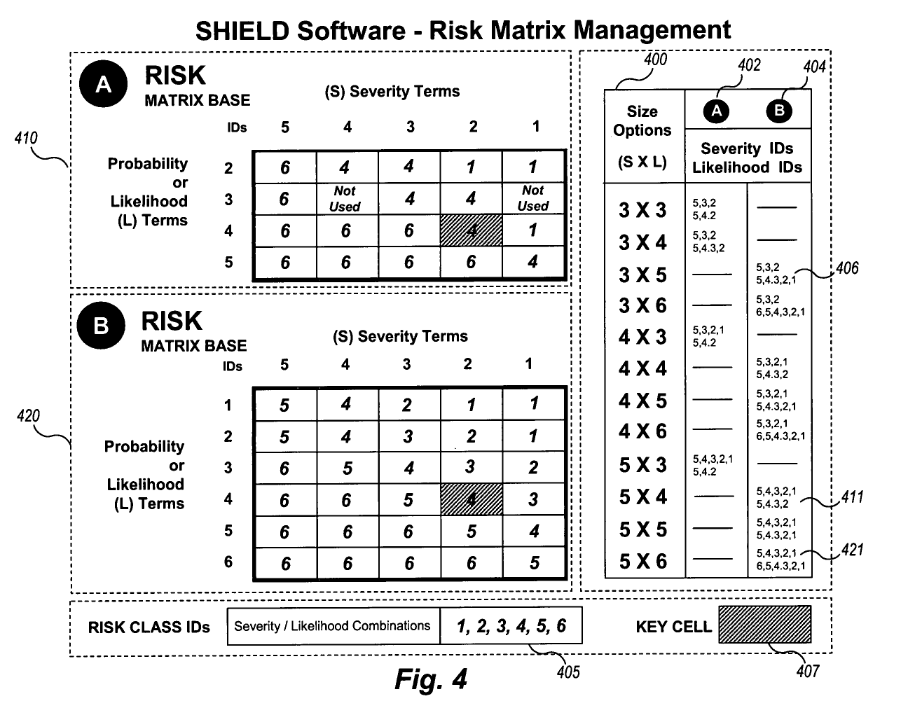

Once the number of severity levels and likelihood levels are specified, the RMDFS creates an appropriate risk matrix to manage risk management decisions for that company. FIG. 4 is an example block diagram illustrating how the RMDFS generates of one or more risk management matrices in an example embodiment. In one embodiment, the RMDFS supports 12 different size matrices (e.g., 3×3, 3×4, 3×5, 3×6, 4×3, 4×4, 4×5, 4×6, 5×3, 5×4, 5×5, and 5×6). In other embodiments a different number may be supported. For each matrix, the first number indicates the number of levels of severity (S) (precision from 3 to 5 levels); and the second number indicates the number of levels of probability or likelihood (L) (precision from 3 to 6 levels). Thus, for example, some companies may wish to only consider 3 levels of precision for managing all risk (a 3×3 matrix), whereas other companies may wish to consider greater precision, for example, the maximum level supported in this embodiment of the RMDFS (a 5×6 matrix).

Each combination of severity level and likelihood level is characterized by a risk classification (risk classification ID), which indicates whether the risk is broadly unacceptable, questionable, or broadly acceptable. The different matrix sizes result in predetermined risk classification combinations, which are derived from the two base risk matrices “A” (410) and “B” (420) shown. In the example illustrated, the risk matrix sizes fall into category “A” type matrices (402), which are those derivable from base risk matrix A (410) or category “B” type matrices (404), which are those derivable from base risk matrix B (420). For example, a 3×5 matrix (406) is computed from base risk matrix B (420) by including the risk classifications from the cells derived from combining columns 5, 3, and 2 from base risk matrix B (420) with rows 5, 4, 3, 2, and 1 from base risk matrix B (420) into a new matrix. Base risk matrix B (420) is the most populated matrix (as it is the largest in this example), and thus can be used to derive any of the other matrices, included the base risk matrix A (410), which, from entry 411, can be seen to include cells from combining columns 5, 4, 3, 2, and 1 with rows 5, 4, 3, 2 from base risk matrix B (420). Although other mappings could be used, the risk classifications 1-6 represent different types of severity and likelihood combinations, and hence an inherent prioritization for which risks ought to be addressed with risk controls first. Each company is responsible for determining the significance of each combination, yet manage each risk as appropriate under the different scenarios where it is present and for different products.

The two categories of risk matrices ensure that the risk classifications used for category A matrices make sense for that level of precision: that they are forced to include one classification of broadly unacceptable risk (risk classification ID=1), one classification of questionable risk (risk classification ID=4), and one classification of broadly acceptable risk (risk classification ID=6). In the category B matrices, 5 levels of precision are used, one reserved for broadly unacceptable risk (risk classification ID=1), three classifications of questionable risk (risk classification IDs=2, 3, and 4), and two classifications of broadly acceptable risk (risk classification IDs=5 and 6). Other mappings are possible in different embodiments.

These predetermined risk classifications are what are used to normalize risk management decisions facilitated by using the RMDFS, regardless of the actual numbers assigned to the severity and likelihood levels, and regardless of the definitional terms that may be employed by a particular company. For example, the worst severity level of a harm (e.g., perhaps a death) may occur 1 time in every 500,000 device uses for one product yet in the same company may occur 1 time in every 1,000,000 uses for a second product. The company would want its departments to manage risk for this severe type of harm the same way—consistent with company risk management philosophy—regardless of the actual numbers. Using the RMDFS, this is accomplished by insuring that the most severe risk and likelihood combination for each product is defined as a “broadly unacceptable risk,” encouraging risk management decisions (e.g., putting risk controls in place) to reduce risk to an appropriate amount for treating a risk considered by the company to be broadly unacceptable.

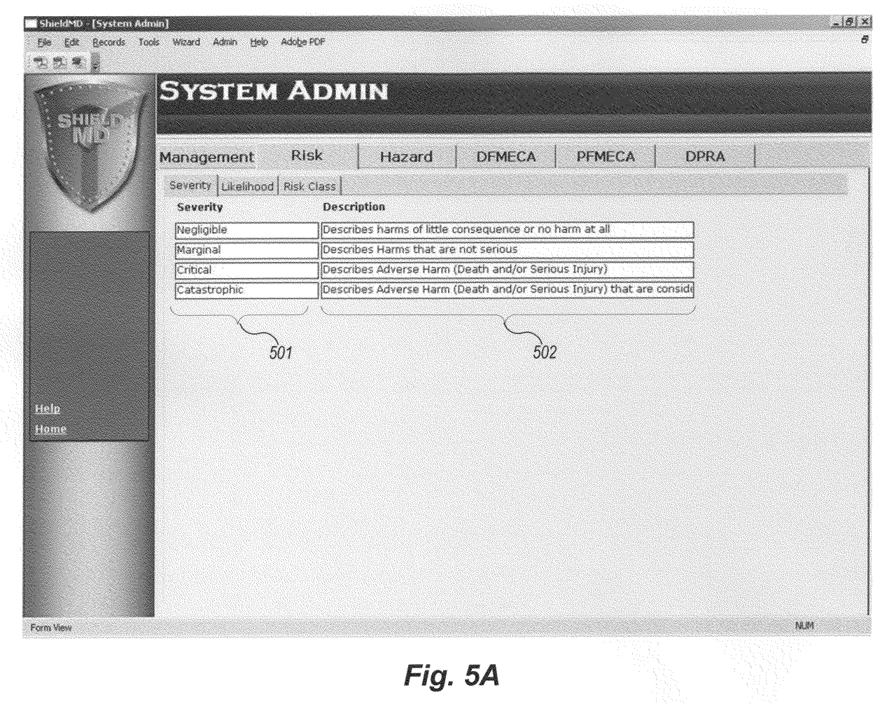

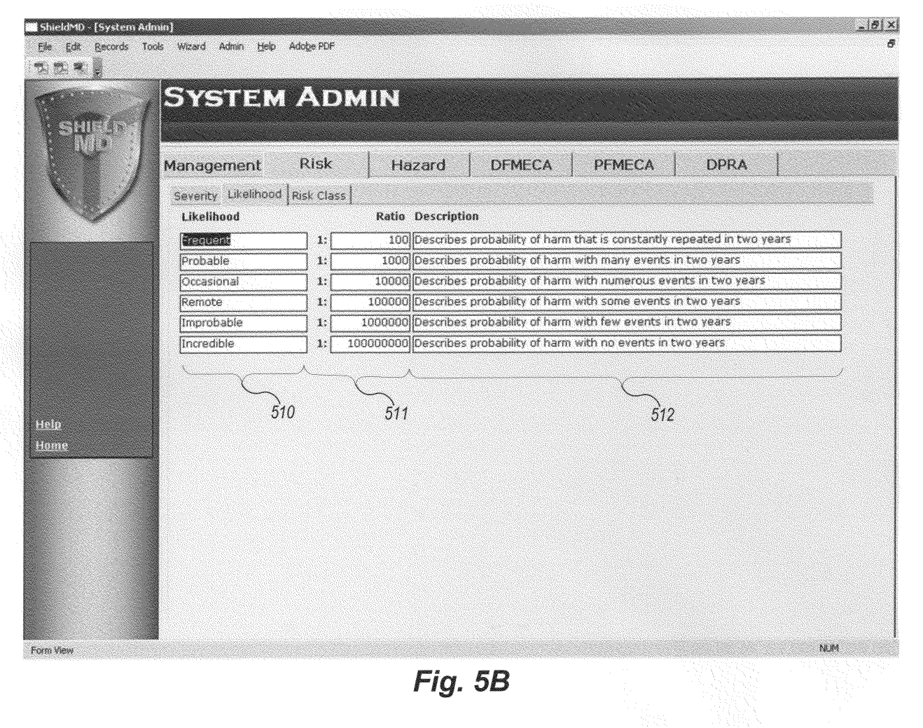

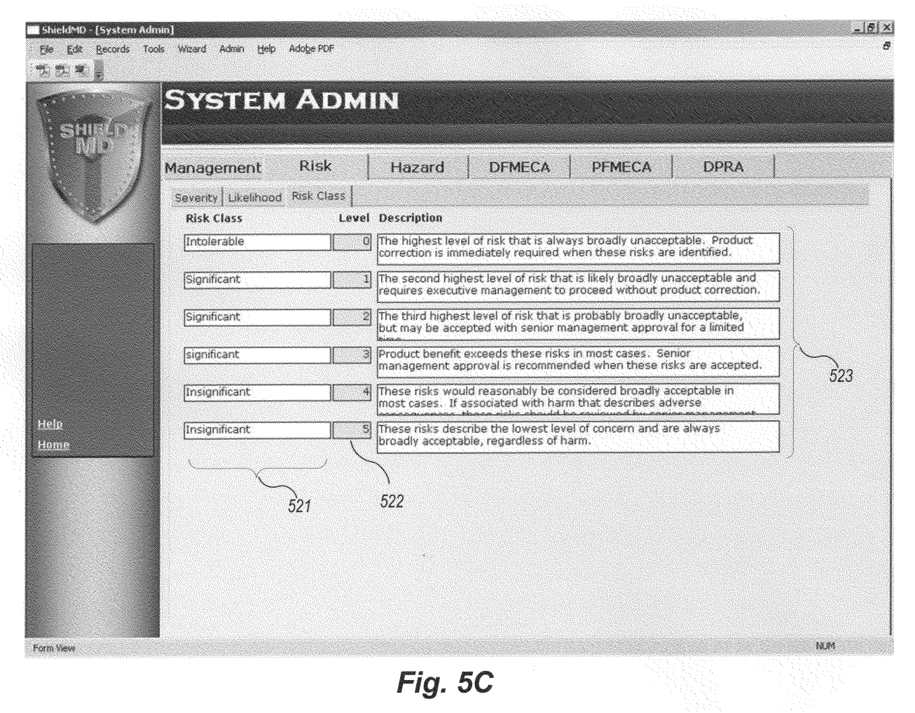

Once the matrix size for the company has been designated (FIG. 3), the corresponding company values are entered. FIGS. 5A-5C are example screen displays for indicating entity-wide term and value definitions for the applicable risk management matrix. These definitions should conform with the business objectives and philosophies for management of risk in the company. In FIG. 5A, descriptions of the severity levels are entered in input field 501 with their respective definitions in field 502. Note that only 4 input fields are available in filed 501, as the matrix size designated by the company is a 4×6 (4 severity levels) matrix. In FIG. 5B, descriptions of the likelihood parameters are entered in input fields 510, 511, and 512, respectively. Again, there are 6 input fields because the matrix size designated by the company is a 4×6 (6 likelihood levels) matrix. In FIG. 5C, descriptions of the six different risk classifications (corresponding to one broadly unacceptable, three questionable, and two broadly acceptable as defined by category B size matrices) are entered in input fields 521, 522, and 523. Again, this embodiment of the RMDFS prevents entry of a number of risk classifications other than what was selected initially.

FIG. 6 is an example block diagram of the resulting 4×6 matrix, which maps the entity specific definitions to a standardized 4×6 risk management matrix. Using the heuristics described in FIG. 4, it can be observed that the 4×6 matrix 600 is derived from base risk matrix B (420) matrix, contains 4 levels of severity and 6 levels of likelihood, and contains columns 5, 3, 2, and 1 combined with rows 6, 5, 4, 3, 2, 1 from the corresponding base risk matrix. As shown, these rows and columns are mapped to the definitions provided by, for example, a user in FIGS. 5A-5C. For example, the most severe level of harm is mapped to “catastrophic,” the most frequent occurring level is mapped to “frequent.” Using the heuristics from FIG. 4, it can be observed that harms of the “critical” and “catastrophic” level that are “frequent” and those of the “catastrophic” level that are “probable” are considered “broadly unacceptable risks.” Using these risk classifications, the RMDFS is able to provide guidance, for example, by indicating hazard scenarios that result in such a risk classification until sufficient risk controls are put in place. In addition, users of the RMDFS are taught a sense of priority of risk controls—for example, that it is more important to institute risk controls for hazard scenarios that result in risk classification ID type 1 risks than others.

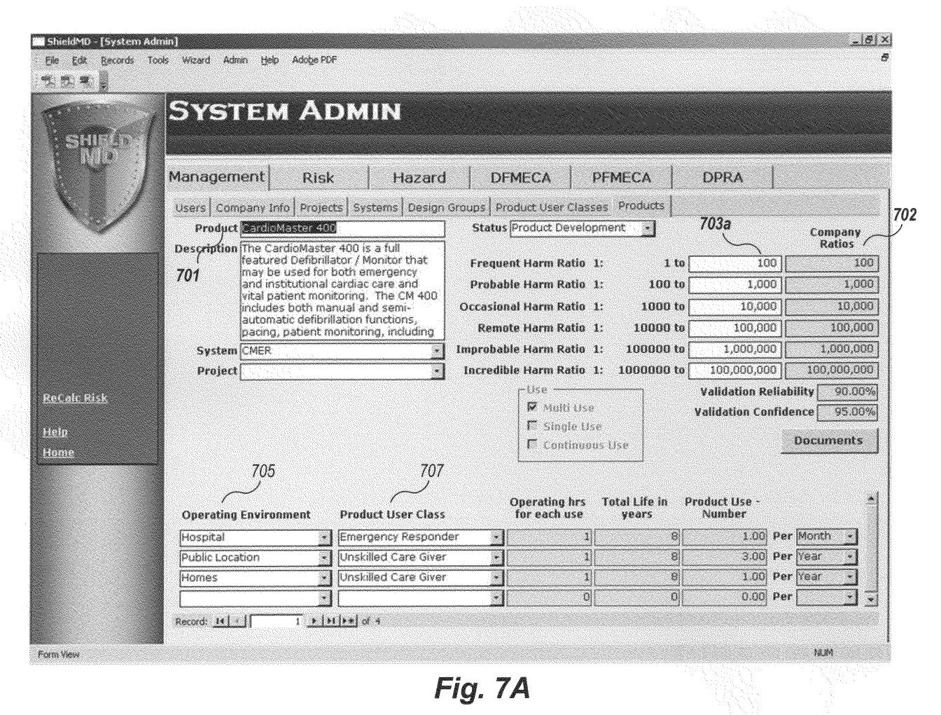

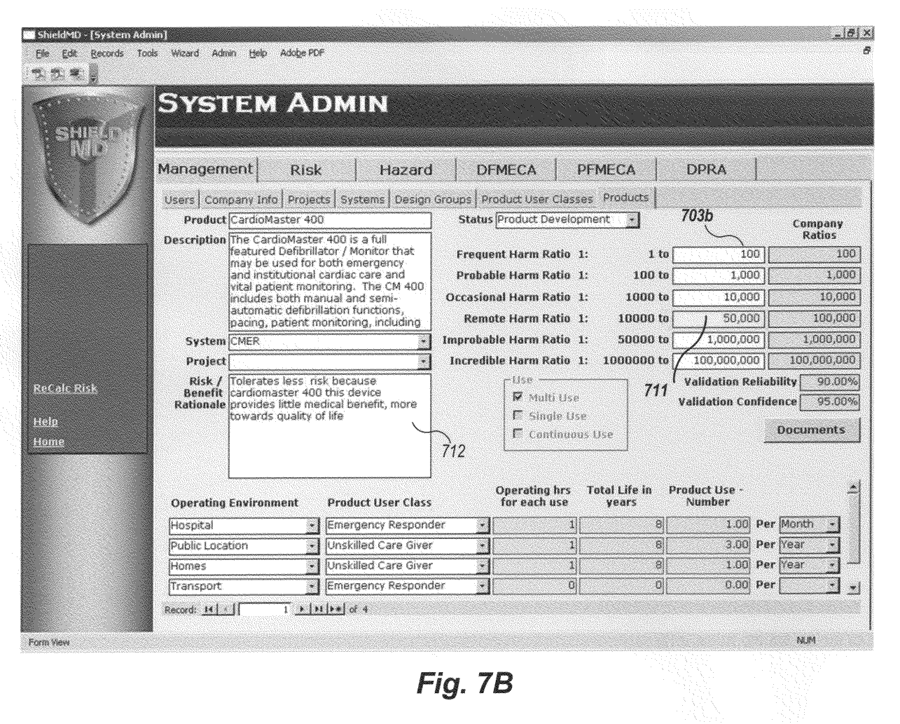

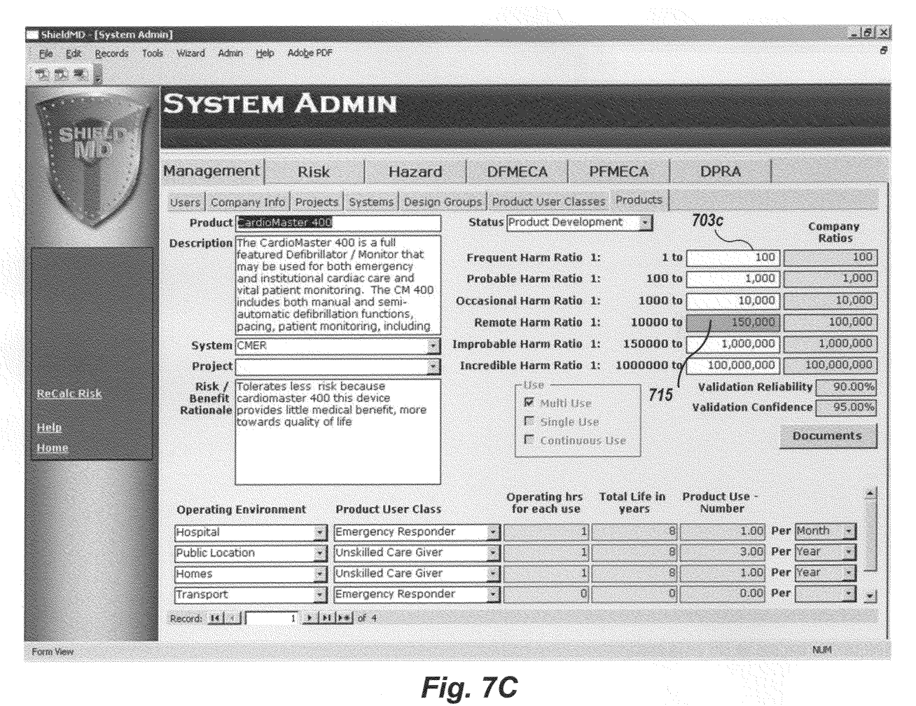

Even though a company may set up company wide risk management matrix guidelines, the RMDFS allows an entity to define guidelines on a per product basis that differ. FIGS. 7A-7C are example screen displays for indicating product-specific risk management terms and value variances within an entity-wide risk management structure. In FIG. 7A, for the product indicated in input field 701, the user may define different likelihood thresholds using input fields 703a. The corresponding company level likelihood thresholds are indicated in fields 702 for easy comparison. The user may indicate other product related use information here as well, such as the different operating environments 705 where the product is used, the different classes of users 706 that will use it, operating hours, life of the product, number used per year etc. These number can be used to assist in estimating risk automatically by the RMDFS.

FIG. 7B illustrates an example of selection of a likelihood threshold in input field 703b for a remote harm (level 4) in a specific product to 1 in 10,000 to 50,000 instead of 1 in every 10,000 to 100,000 uses. Since this likelihood range is worse than the company wide stated goal, it is designated with a color—yellow. Other indications could be used, for example, icons, symbols, textures, etc. In the example shown, the RMDFS directs the user to indicate a rationale for the decision in input field 712.

Similarly, FIG. 7C illustrates an example selection of a likelihood threshold in input field 703c for a remote harm (level 4) in a specific product to 1 in 10,000 to 150,000 instead of 1 in every 10,000 to 100,000 uses. Since this frequency is better than the company wide stated goal, it is designated with a different color blue. Other indications could be used, for example, icons, symbols, textures, etc.

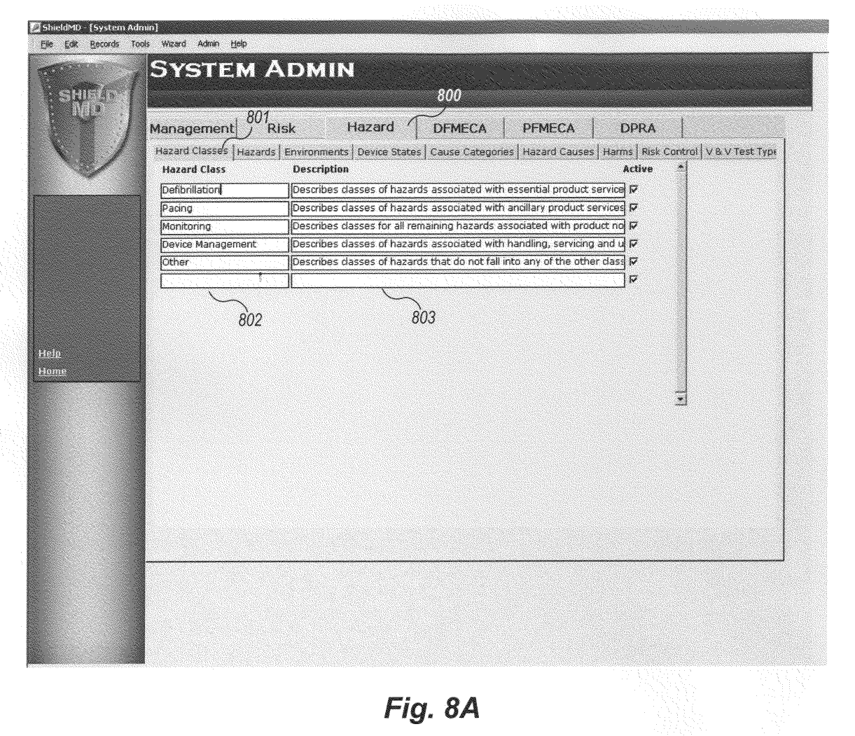

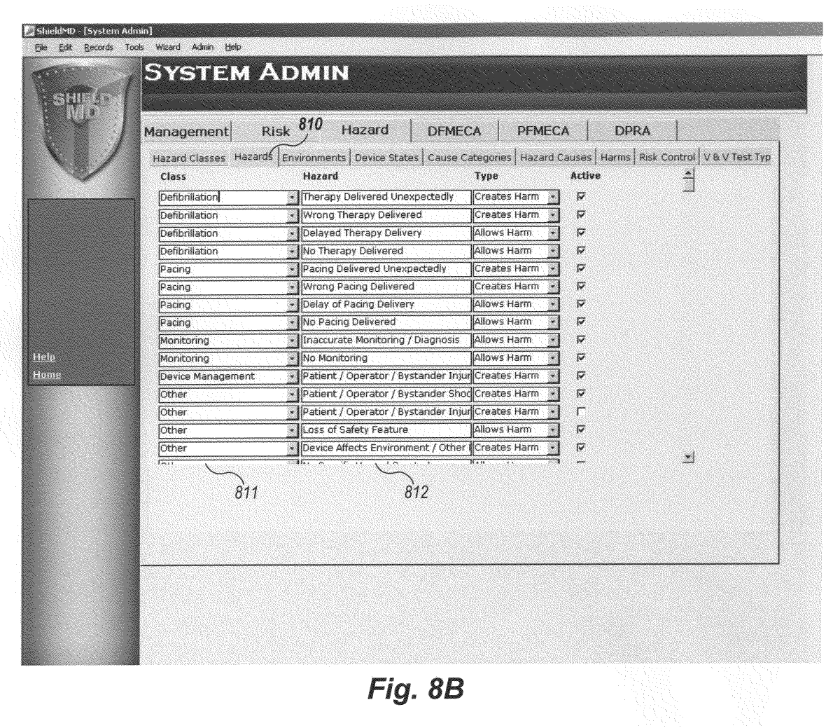

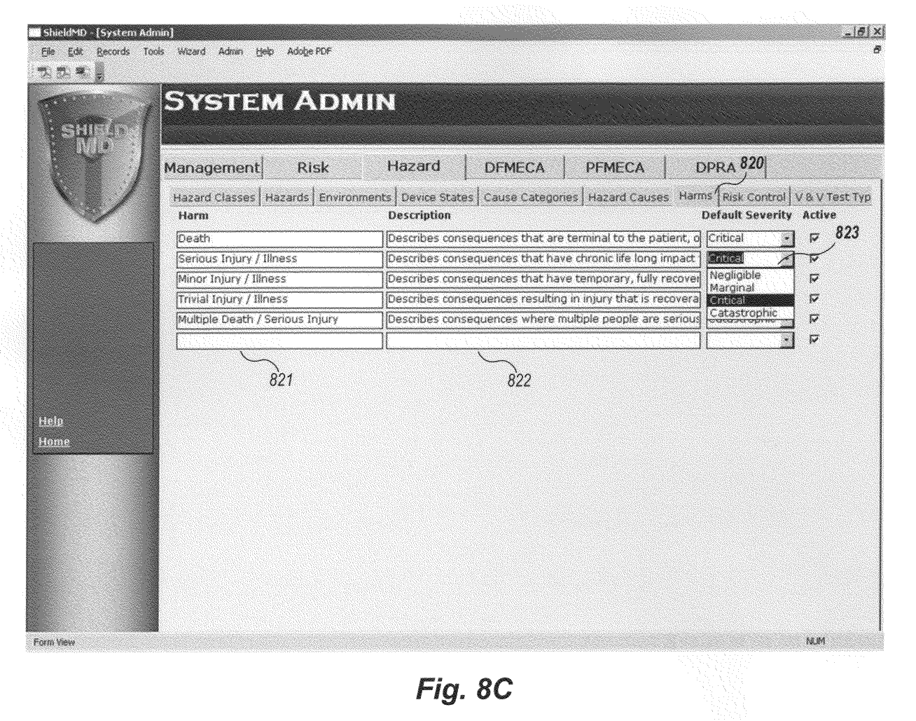

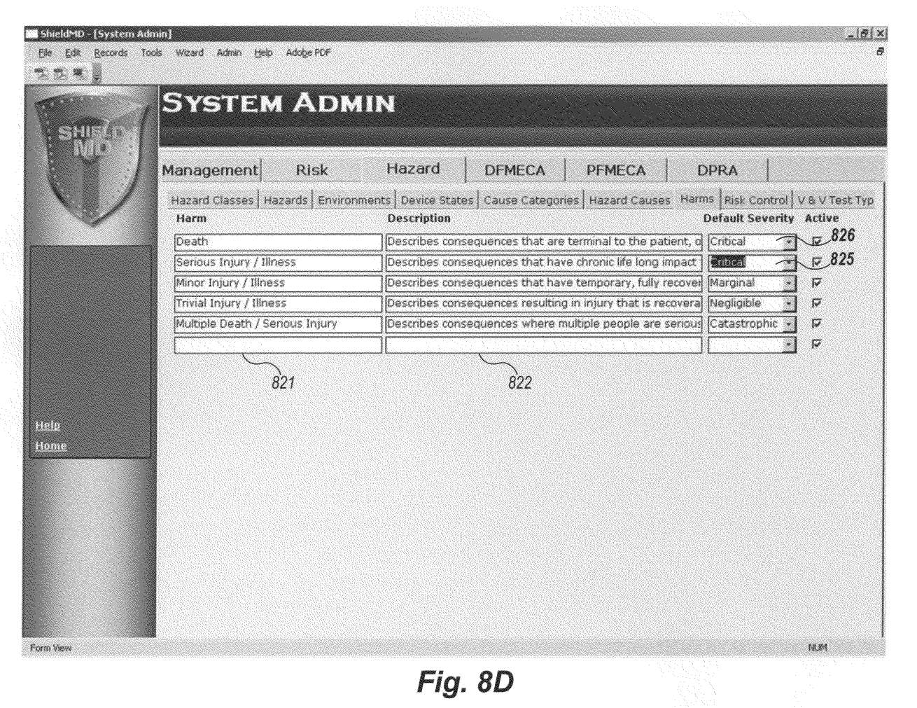

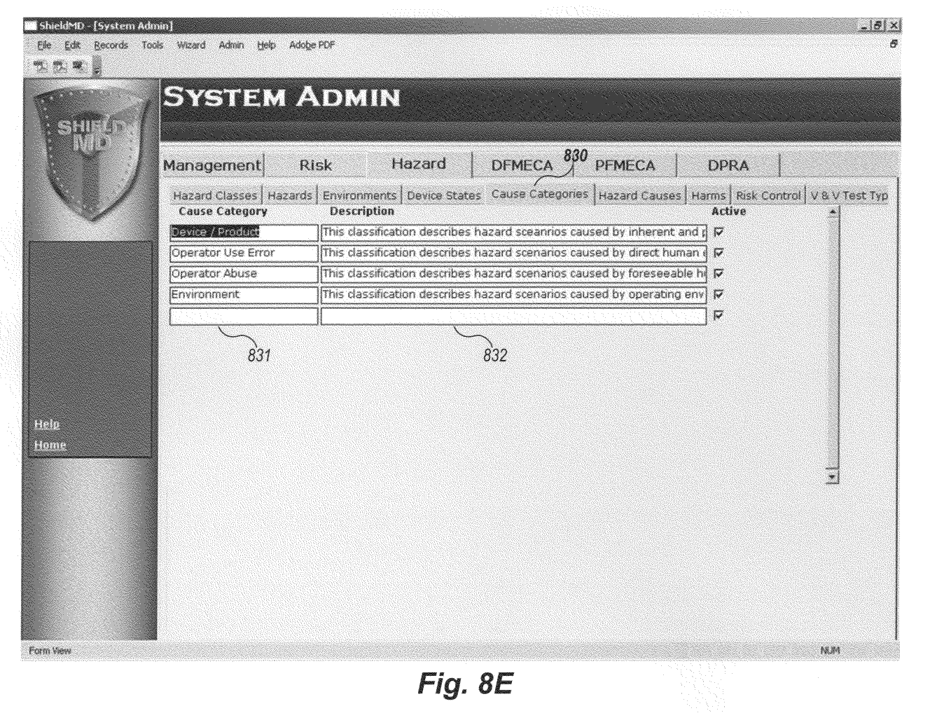

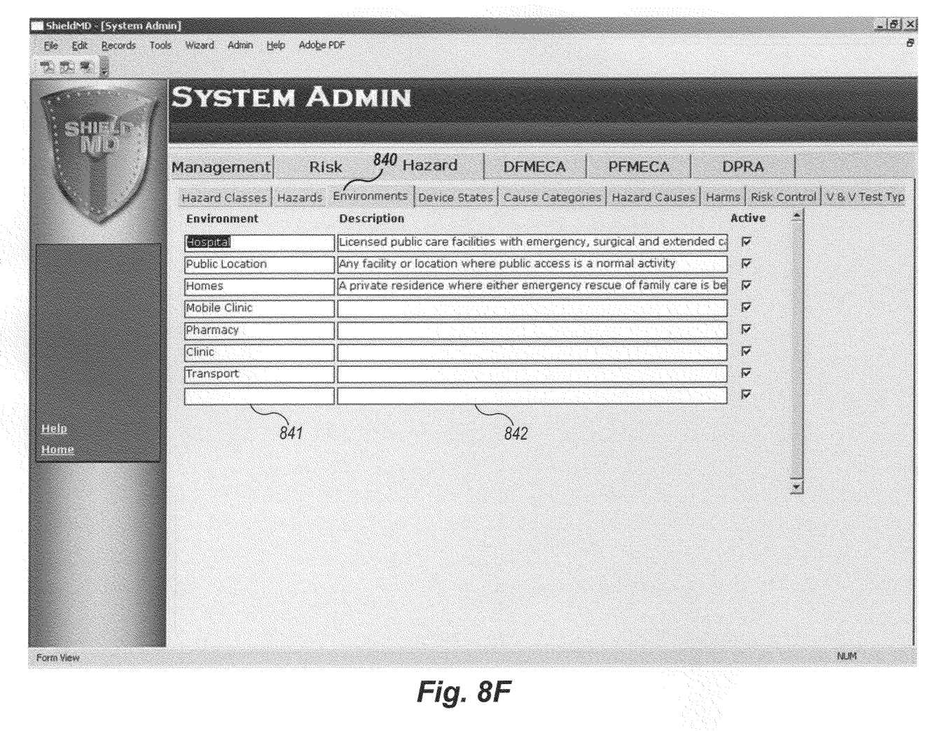

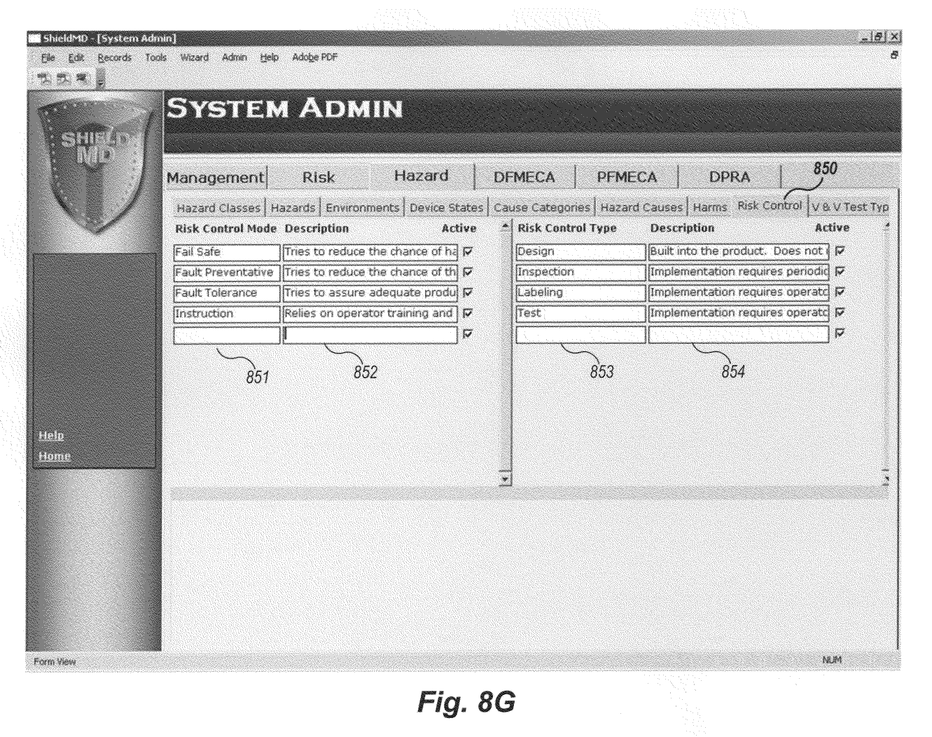

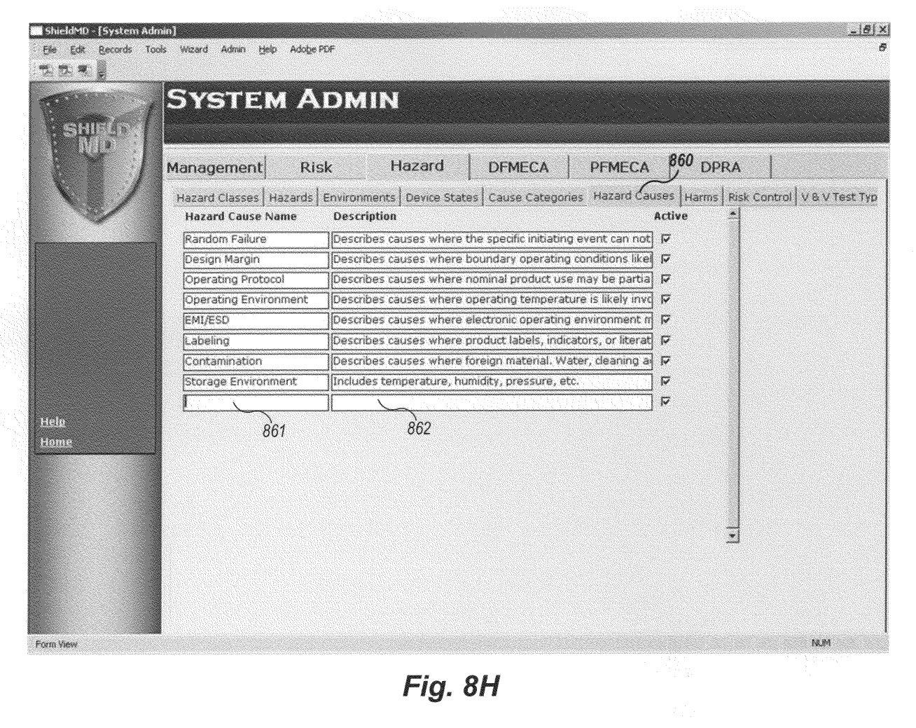

FIGS. 8A-8H are example screen displays for indicating hazard, harm, and risk control related parameters for use in defining hazard scenarios in an example Risk Management Decision Facilitator System. For example, under the hazard setup interfaces 800, a user can define different parameters for easier entry of hazard scenarios in, for example, the Hazard Scenario component 202 of FIG. 2. For example, in FIG. 8A, different hazards may be grouped into one or more hazard classes 802 which are defined using the hazard class form 801. Once the hazard classes are defined, the various hazards 812 may be assigned to a hazard class using form 810 (see FIG. 8B). As another example, the various harms can be identified and defined using the harms form 820 in FIG. 8C. Each harm is entered in harm input field 821 along with a description in field 822, and is then assigned in field 823 to one of the severity levels available for the specified entity wide risk matrix. For example, in the form illustrated in FIG. 8C, there are five harms listed but only four severity levels assigned to the underlying 4×6 risk matrix. Thus, two of the harms in list 821 must be assigned to the same severity level 825 and 826, as shown in FIG. 8D. In FIG. 8E, the cause category form 830 cause categories may be defined for the various harms in cause category input fields 831 and 832. In FIG. 8F, using the environments form 840, the different environments where harm may be manifested can be entered in environment input fields 841 and 842. Also, in FIG. 8G, using the risk controls form 850, the types of risk controls may be entered along with their descriptions in fields 851-854. In FIG. 8H, using the hazard causes form 860, the potential causes the various hazards may be entered along with their descriptions in fields 861-862. Other forms for inputting parameters for use in setting up hazard scenarios may be made available in other embodiments.

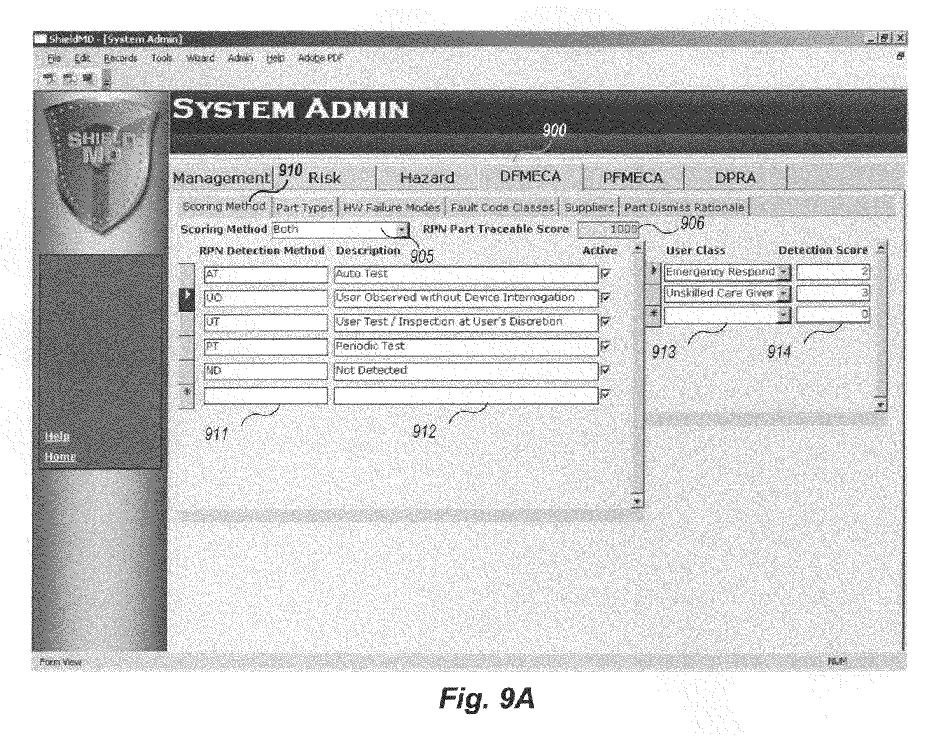

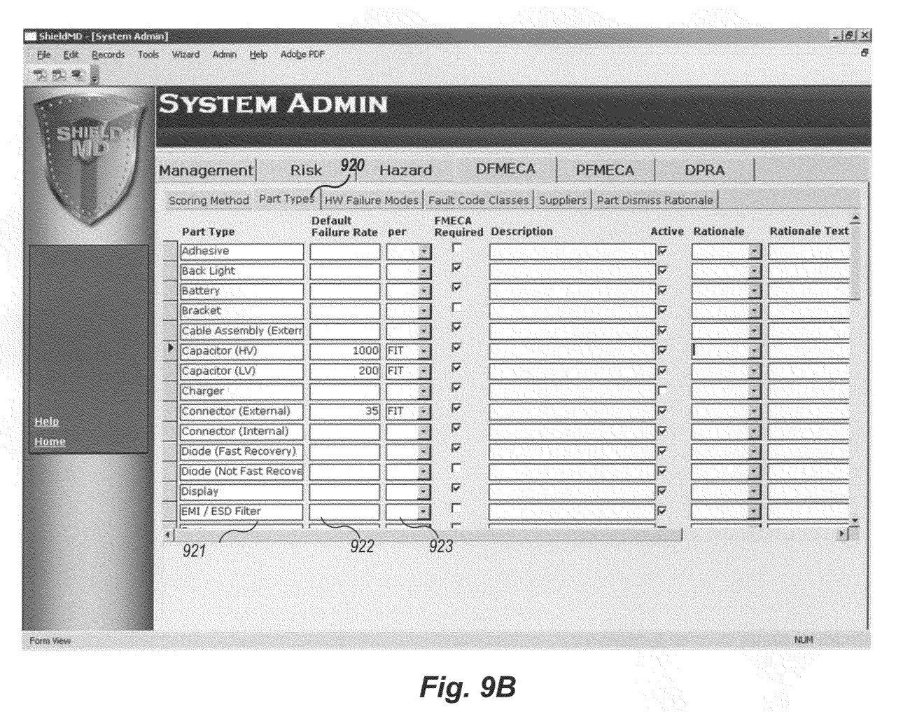

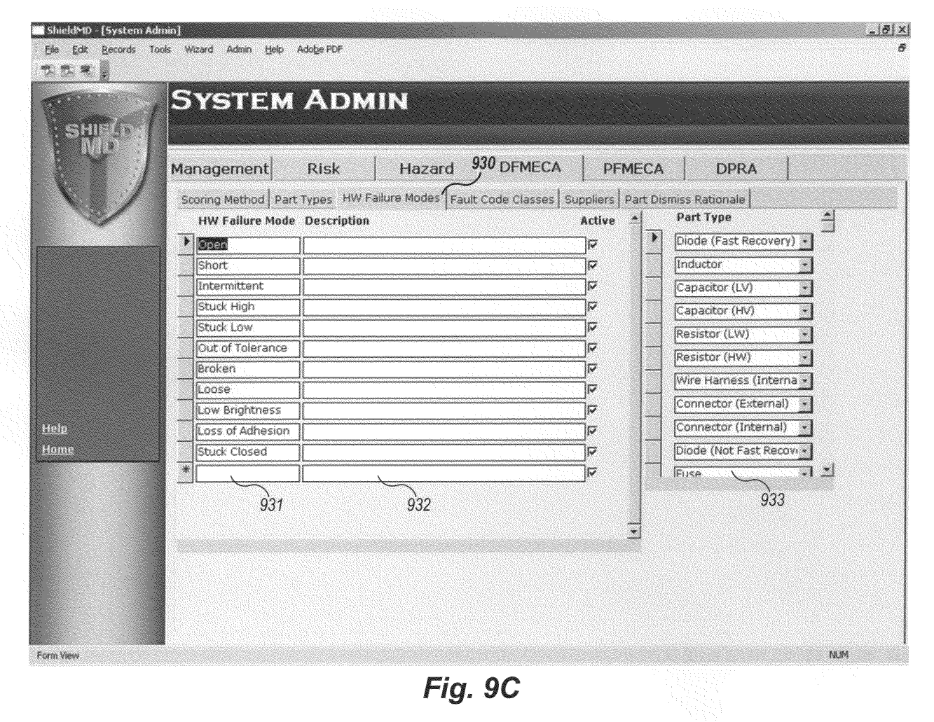

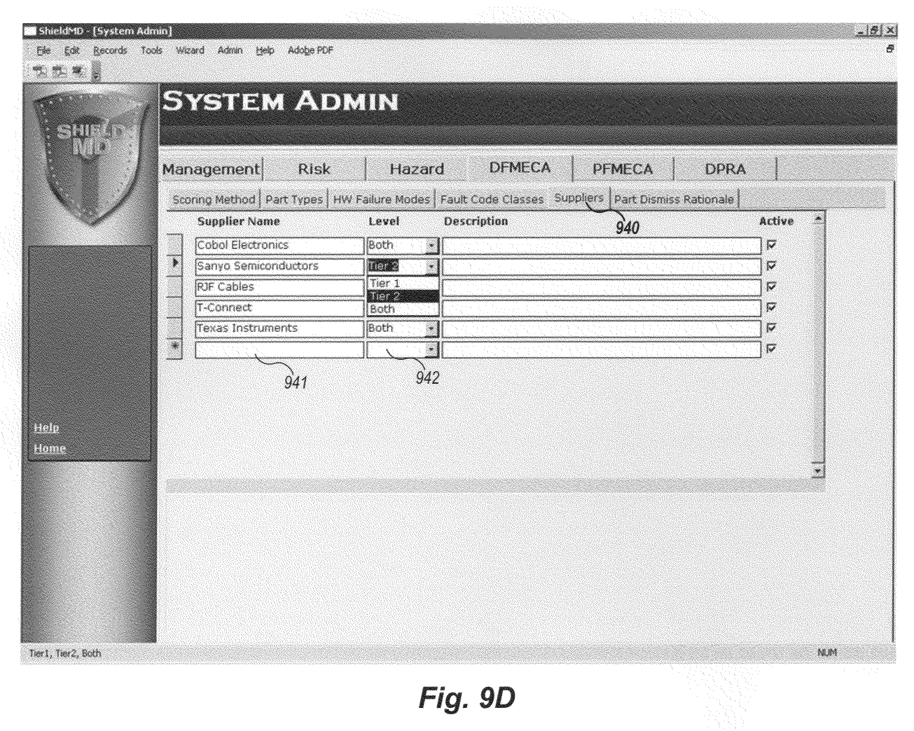

FIGS. 9A-9D are example screen displays for indicating component part related parameters for use in analyzing and assessing risk related to inherent failures of subcomponents of a product in an example Risk Management Decision Facilitator System. For example, under the DFMECA setup interfaces 900, a user can define different parameters for easier entry of sub-assemblies and other part information in, for example, the design failure analysis (e.g., DFMECA) component 203 of FIG. 2. For example, in FIG. 9A, using the scoring method form 910 the user may define different scoring methods 905 for use in establishing a measure of detectability of a part failure resulting in a harm. For example, the RPN method specifies a risk priority number; whereas an MER specifies mission essential reliability. If RPN or Both are indicated in field 905, then a part traceability number is generated in field 906, which provides a measure of detectability of a failure. The embodiment of RMDFS uses a different formula for RPN, which is S²×L×D (detectability). Squaring the severity factor gives much greater weight to those failures that cause more severe harm. The detection methods are entered in fields 911 and 912.

Other component related parameters may also be specified. For example, in FIG. 9B, different part types and corresponding failure rates may be defined in input fields 921, 922, and 923 using the part types form 920. In FIG. 9C, the different failure modes may be defined in input field 931 and associated with each part type in input field 933, using the HW failure modes form 930. In FIG. 9D, different suppliers and their types (first tier, second tier, etc.) may be specified using input fields 941 and 942 respectively from suppliers form 940. Other forms and parameters are possible and may be specified in similar manners.

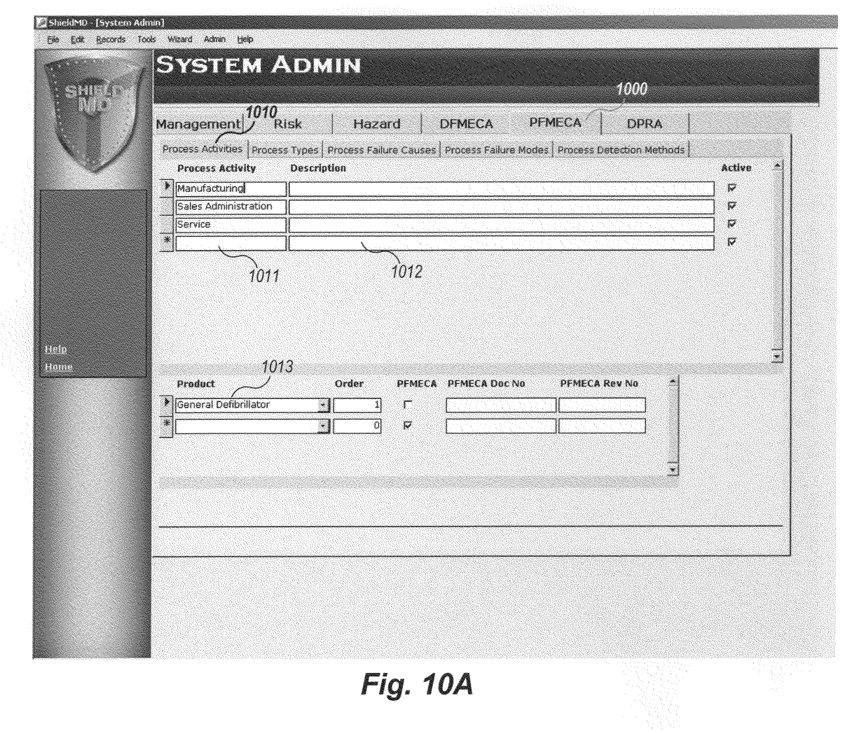

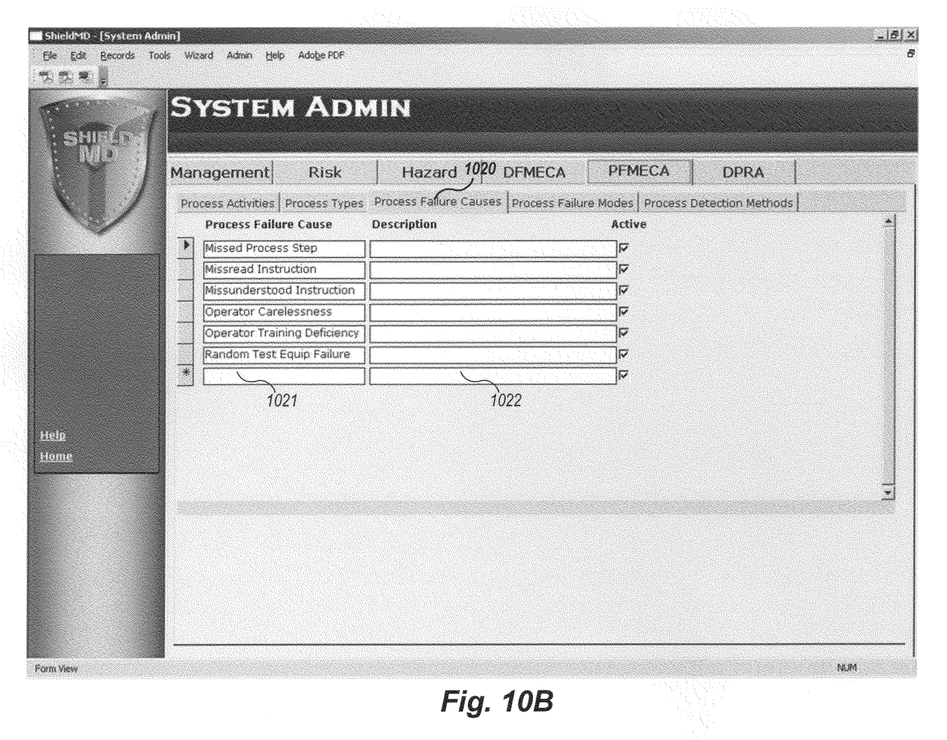

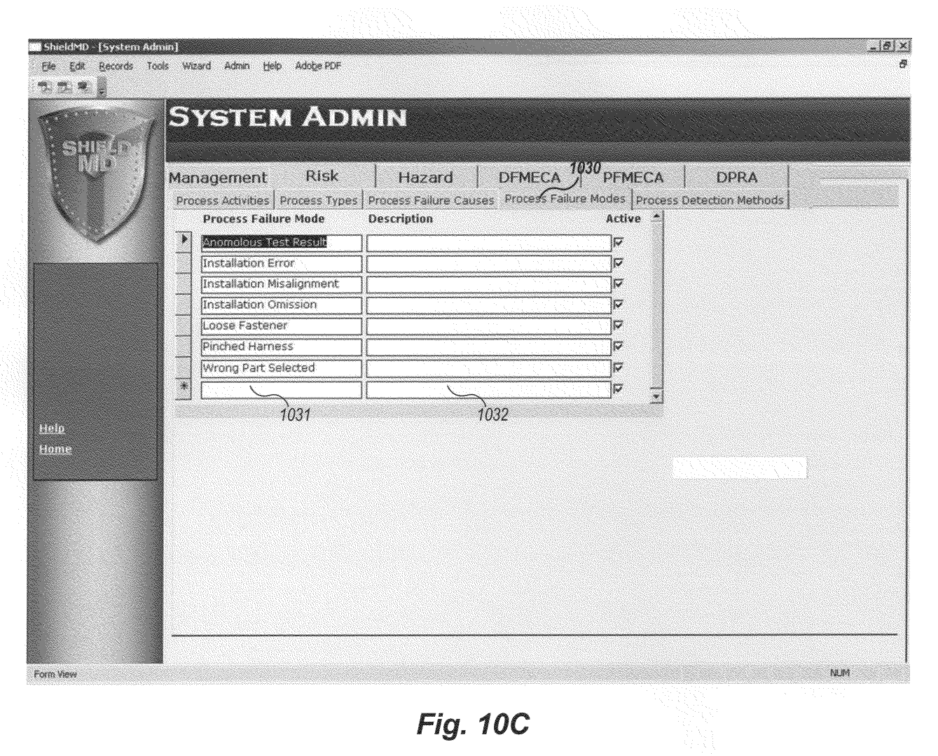

FIGS. 10A-10C are example screen displays for indicating process related parameters for use in defining risk controls for and assessing risk related to process induced failures of a product in an example Risk Management Decision Facilitator System. For example, under the PFMECA setup interfaces 1000, a user can define different parameters for easier entry of process failures, for example, the process failure analysis (e.g., PFMECA) component 204 of FIG. 2. For example, in FIG. 10A, using the process activities form 1010, different high level processes may be established in input field 1011 and associated in order with various products in input field 1013. Linkage to appropriate documentation may also be provided. In FIG. 10B, using the process failure causes form 1020, different process failure cause descriptions may be entered and described in fields 1021 and 1022, respectively. Similarly, in FIG. 10C, using the process failure modes form 1030, different ways that can cause the process to fail are described in input fields 1031 and 1032. Other forms and parameters are also possible.

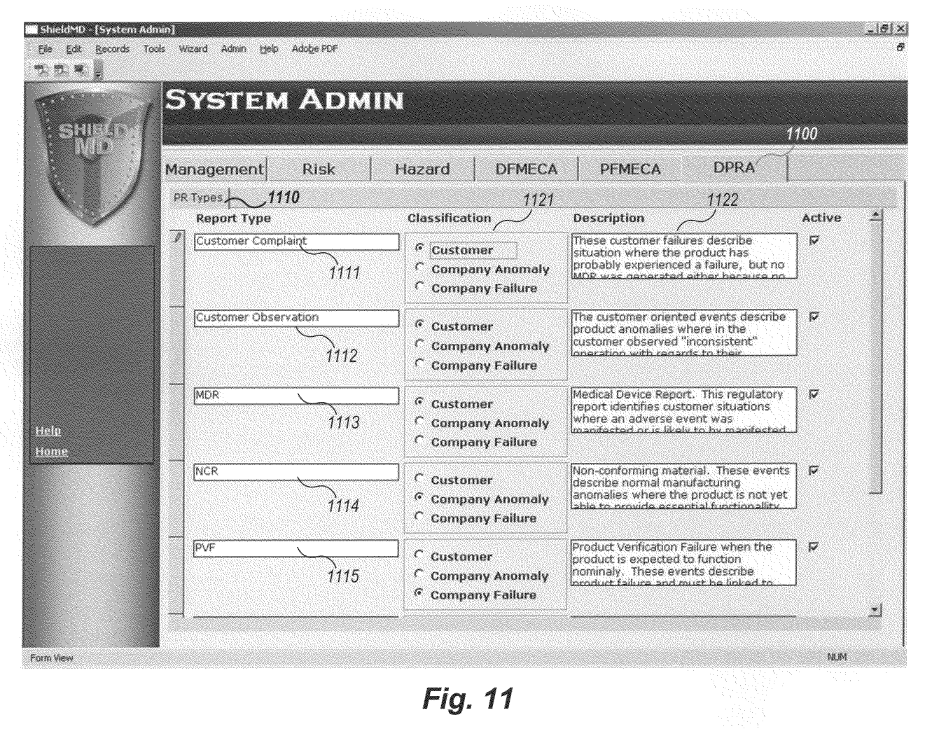

FIG. 11 is an example screen display, in an example Risk Management Decision Facilitator System, for indicating the types of reports to be used to identify and characterize demonstrated risk experience in using a product. For example, under the DPRA setup interfaces 1100, a user can define different reports that can be used to record experiences with harms to use in, for example, the observed experience analysis (e.g., DPRA) component 205 of FIG. 2. For example, in FIG. 11, using the PR types form 1110, the different report types 1111-1115 may be specified. Each report type is classified in field 1121 to be external or internal to entity operations and given a description in field 1122.

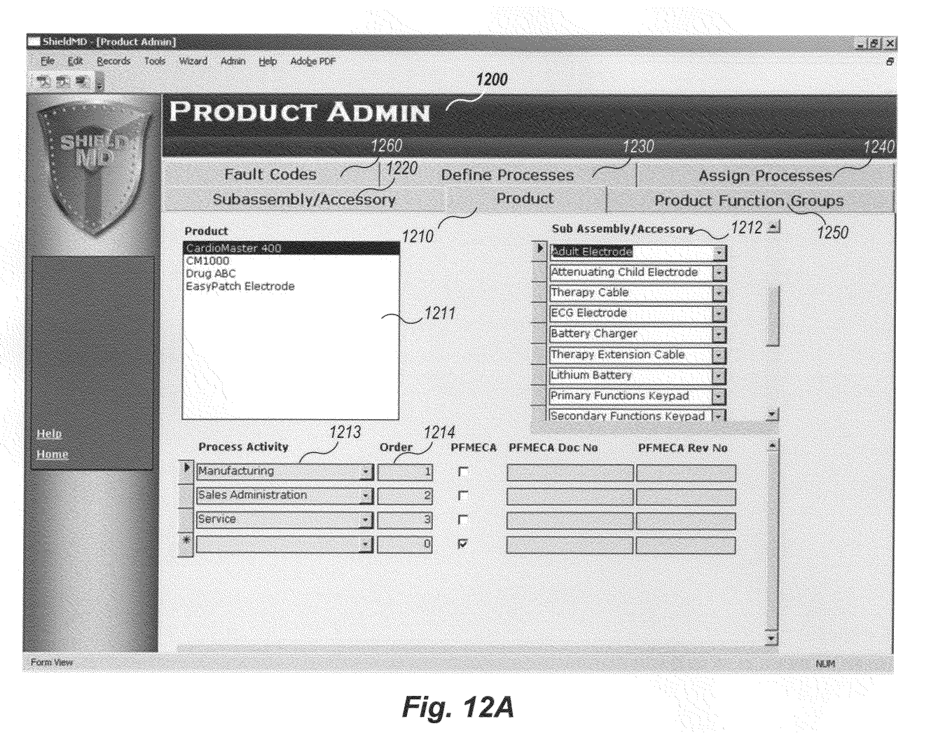

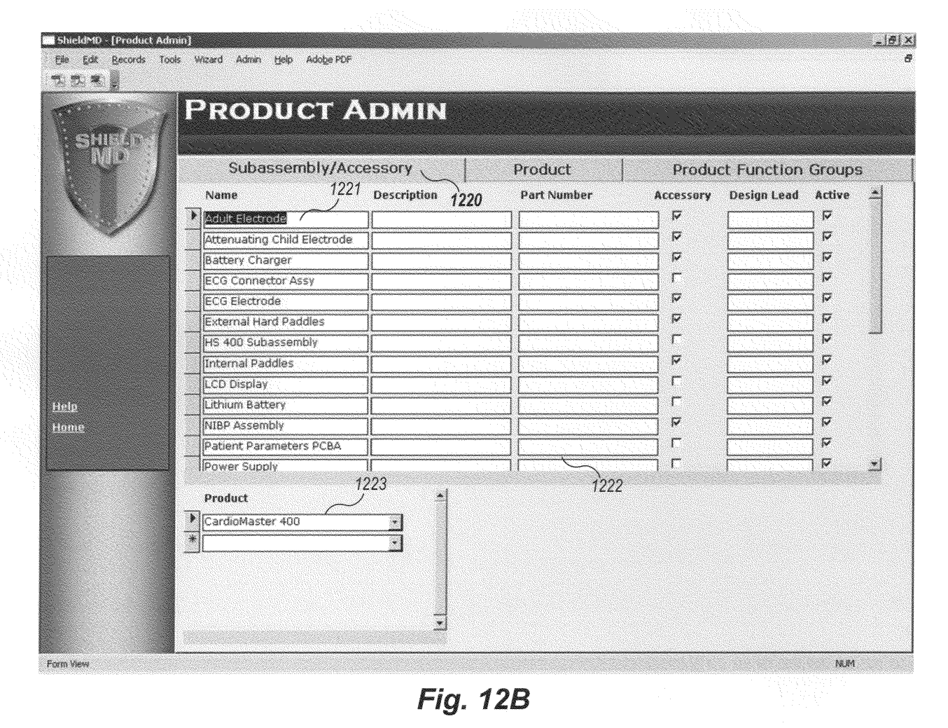

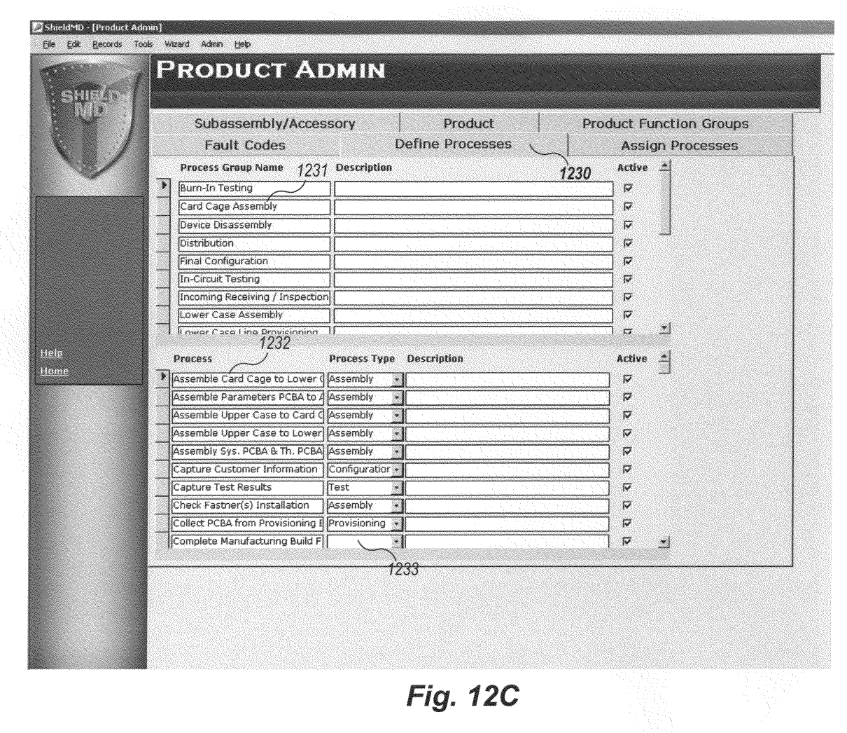

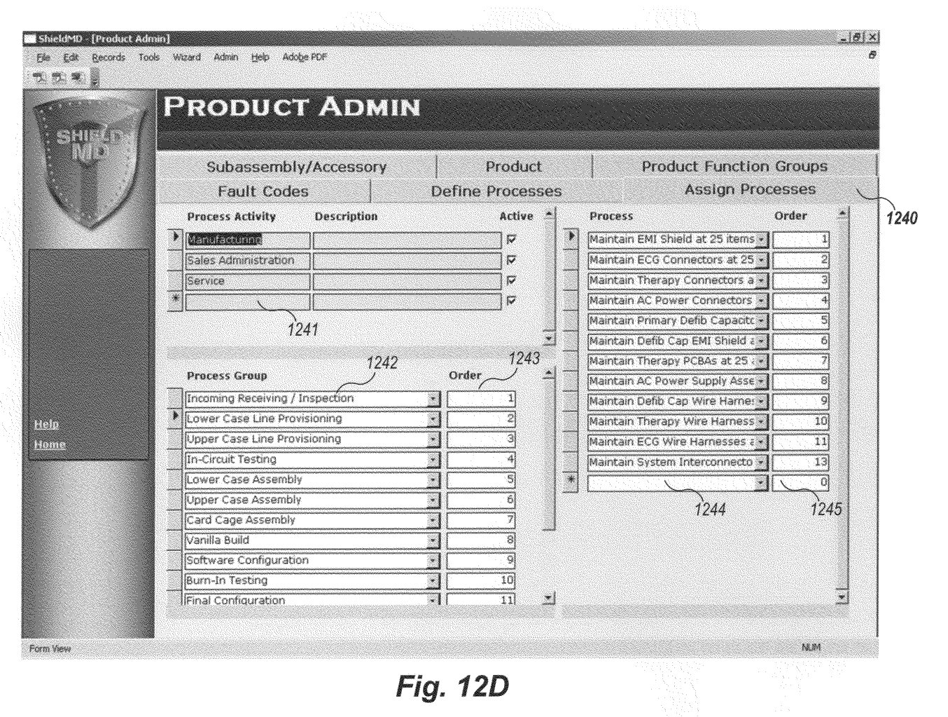

In addition to the System Admin module, an example embodiment of a Risk Management Decision Facilitator System provides a Product Admin module. The example Product Admin module may be implemented by the administration and setup component of a Risk Management Decision Facilitator System shown in FIG. 2. FIGS. 12A-12D are some example screen displays from an example Product Admin user interface for defining and decomposing product sub-assemblies, processes, and functions that support the product's lifecycle. These screen displays also enable an administrator to assign a responsible individual (and/or group) to the various sub-assembly productions and process, which enables management track effectiveness of a particular set of decisions and/or risk control techniques. In particular, under the product admin interfaces 1200 a user can define different aspects of the products whose risk are being managed.

The example Product Admin user interface shown in FIG. 12A includes six different setup interfaces: Product 1210, Subassembly/Accessory 1220, Define Processes 1230, Assign Processes 1240, Product Function Groups 1250, and Fault Codes 1260. Each of these interfaces further contain other forms (templates, input windows, etc.) for indicating additional parameters, which can be used for defining relationships between sub-assemblies and between processes used in the lifecycle of a product and for defining possible failures. Other setups and screen displays could also be made available.

More specifically, in FIG. 12A, under the product form 1210, each product 1211 can be characterized at a high level to indicate which process activities may be applicable 1213 to the process being characterized and which sub assemblies 1212 (e.g., sub-components of one or more parts) are present. In FIG. 12B, under the sub-assembly form 1220, each sub-assembly 1221 for a product 1223 (in this case the CardioMaster 400) is described, including its part number if available (part numbers can be entered elsewhere). In FIG. 12C, under the define processes form 1230, process groups are defined in input field 1231 and processes in field 1232 with their corresponding process types in field 1233. This allows various process activities to be grouped together so that they can be managed together. For example, for a particular process group, there are likely a set of activities to be performed in a particular order. In FIG. 12D, under the assign process form 1240, the particular process activities are assigned to the various product groups and their ordering defined. In addition, the process groups may be ordered, as they are likely to be performed in a particular order. In particular, a process group is selected in field 1242 for a particular activity along with their respect ordering 1243. For each selected process group from field 1242 (where the arrow is currently located), the applicable processes are defined in field 1244, along with their respective orders 1245, which can be set. These assignments support process flow by identifying both a process group order within each process activity and a process order within each process group. Fault codes for failures for the various process activities are set in form 1260. Other functions are possible.

Note that the “Active” check boxes in the administration and setup screen displays (e.g., the System Admin and Product Admin modules) are included to indicate when particular parameters are to be made available to the live User Interface. Other indications may be supported.

One of the additional functions available through administration and set in an example Risk Management Decision Facilitator System is to assign a particular user to have risk management decision responsibility on a per product basis. In some cases, access to the various data can also be controlled in a similar manner by assigning users to different levels, which are associated with a particular product.

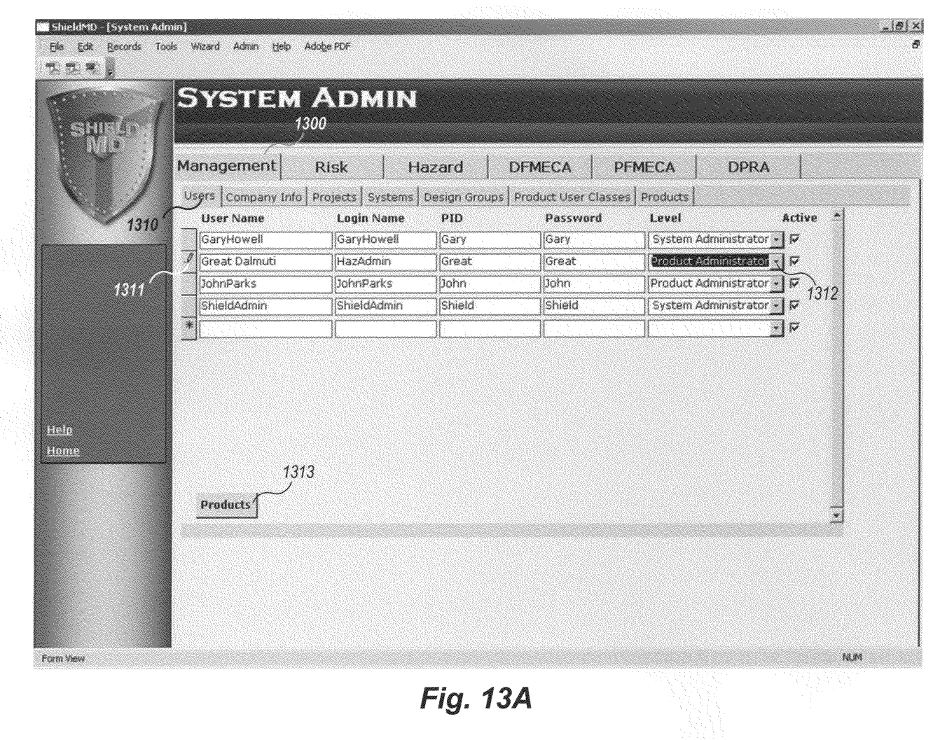

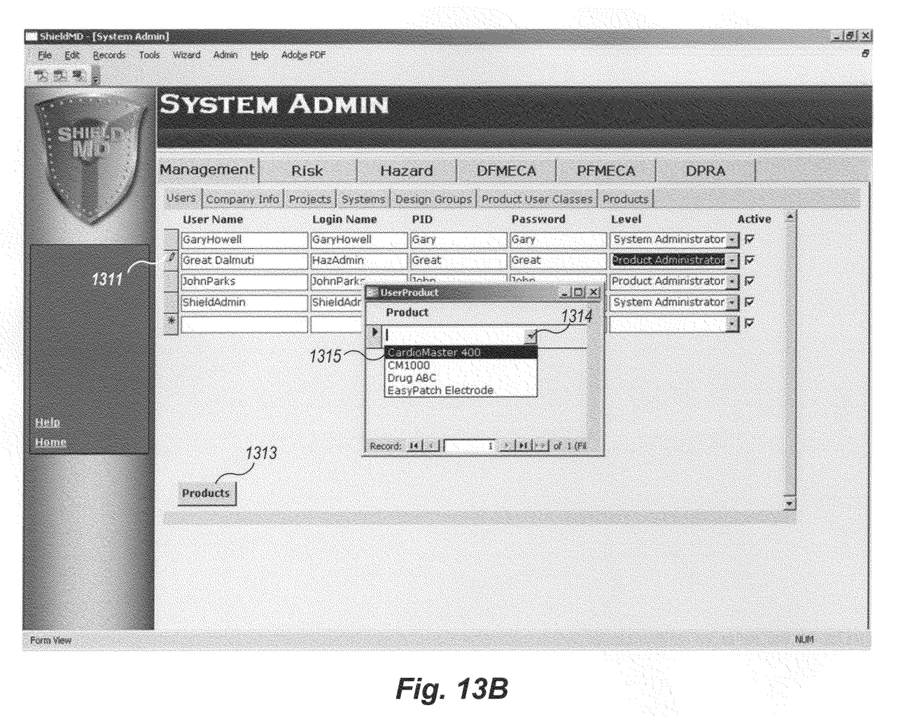

FIGS. 13A-13B are example screen displays for assigning user level or group level risk management responsibility on a per product basis. In one example embodiment, this function is performed from the management form 1300 in the System Admin module. In particular, using the users form 1310, a user, for example user 1311 may be assigned to a particular level, in this case Product Administrator 1312. In one embodiment, all users assigned to the same level 1312, will have the same privileges, including the ability to edit hazard scenarios to perform risk assessment and to assign risk controls to them in order to manage risk. In addition, using a user interface control, for example button 1313, each user may be assigned to a particular product. FIG. 13B illustrates a pulldown control 1314 where the user 1311 can be assigned to a particular product 1315. Other arrangements for assigning users different responsibilities can be supported.

As described in step 102 in FIG. 1, another function of a Risk Management Decision Facilitator System is to allow users to identify, characterize, and assess risks by defining hazard scenarios and to define and assign risk controls to manage identified risks. FIGS. 14A-18 illustrate an example of using an RMDFS to facilitate risk management decisions. In particular, these figures illustrate how to define an example hazard scenario, including assessing the risk that the hazard scenario will bring about an identified harm, and identifying possible design and process failures that contribute to such risk and possible risk controls to alleviate or mitigate such failures. They also show how observed experience of an event causing a harm that can be linked to that hazard scenario can be used to instill corrective action and predict future risk. Although only one hazard scenario is described, it is to be understood that the identification and characterization of other hazard scenarios for each product managed by a company would be similarly performed. That is, as described in FIG. 1, each hazard scenario is identified and assigned risk controls, and then each possible contributing product failure and process failure is in turn linked to the hazard scenarios it may contribute to. Risk is assessed both before the risk controls are identified and after, giving the responsible company member a good feel for how effective the planned risk controls may be in controlling the identified risk. Again, as described earlier, the risk matrix selected for the company is used to ensure the characterizations of linked product and process failures are displayed consistently—for example, characterizations that indicate a type of harm and/or likelihood of failures will be automatically linked to appropriate severities and risk classifications.

FIGS. 14A-14E are example screen displays illustrating data entry for an example hazard scenario in an example Risk Management Decision Facilitator System. The Hazard Scenario Data Entry module 1400 includes a Hazard Entry form 1410 and a Risk Control Entry form 1430. Duplicates are shown for easily defining new entries. In the illustrated example, a hazard scenario, with an ID of “2” is identified in hazard field 1401, is characterized in fields 1402 as follows:

| | |
|---|---|
| Hazard | Therapy Delivered Unexpectedly |
| Environment | Hospital |
| Device State | during Patient Care |
| Category | Device induced |
| Cause | Random failure from customer's perspective |
| “Root” cause | Defibrillator discharges on it own |
| Specific cause | Isolation relay stuck in closed position |

Risk Assessment area 1407 shows the Risk Assessment of this event, prior to application of any risk controls in fields 1405 and 1406:

| | |
|---|---|
| Harm | Death |
| Severity | Critical |
| Likelihood (Probability) | 1 patient treatment in 100 essential uses, which |
| | is termed “frequent” according to the risk |
| | matrix mappings |
| Risk Classification | Intolerable (0) |

One risk control has already been identified in Risk Controls area 1410:

| | |
|---|---|
| Tag | RC007 |
| Description | Device conducts state consistency checking |
| | between microprocessors and functions to assure |
| | the device does not enter a state of non-control . . . |

After applying this one risk control, risk assessment fields 1411 show that the risk of the hazard occurring has been lessened substantially:

| | |
|---|---|
| Risk Control Factor | 500 (risk control is 99.8% effective) |
| Post RC Severity | is critical, even after applying the risk control |
| Post RC Likelihood | 1 in every 50000 essential uses, which means it is |
| | “remote” according to the risk matrix mappings |
| Post RC Risk Class | Significant (3) |

Thus, after applying this one risk control, the risk has been move to a risk classification that is much better—but it hasn't become negligible.

The residual risk assessment after applying all of the risk controls is shown in Residual Risk Assessment area 1415. Since only one risk control has been entered to address this hazard scenario, the risk assessment shown in fields 1416 is the same as that shown in fields 1411.

FIG. 14B illustrates some of the details regarding the risk control that was applied to hazard scenario ID 2 in FIG. 14A (risk control ID=007). Edits to the risk control (for example, its likelihood of harm if it fails) can be made through the Risk Control Entry form 1430. Field 1437 shows that a risk control entry for Risk Control Tag ID=007 currently is being displayed, with a Risk Control Factor of 500 (field 1432). The risk control (RC) factor is a measurement of effectiveness of a risk control (i.e., how much risk is created when the risk control fails) calculated as: Effectiveness=100*(1−1/Factor). Thus, a RC factor of 10 is 90% effective, an RC factor of 100 is 99% effective, and an RC factor of 500 is 99.8% effective (100*(1−1/500)=100*(0.998)=99.8%). The description field 1434 of this risk control is the same as that displayed in fields 1411 if FIG. 14A. Risk controls can themselves sometimes cause more risk if they fail. The Risk Control Risk Assessment areas 1431 shows the hazard caused by this risk control (RC007) failing is:

| | |
|---|---|
| Harm | trivial injury or illness (harm field 1433) is the only |
| | risk |
| Likelihood | 1 in every 4000 essential uses (field 1436) which |
| | comports with the “occasional” definition in the risk |
| | matrix |
| Severity | Negligible |
| Risk Classification | Insignificant (5) |

This risk classification is very low, since the harm is really low and likelihood only occasional. This risk control (tag=RC007) has been previously linked to 2 hazard scenarios, one of which is the scenario shown in FIG. 14A. These hazard scenario links are shown in area 1435. The risk assessment changes to that scenario that are based upon the risk control shown are repeated in area 1437. These are the same as those shown in the corresponding hazard scenario data entry (see fields 1411).

FIG. 14C illustrates the addition of another risk control to the hazard scenario depicted in FIG. 14A. In particular, via pulldown control 1441, the user selects one of the risk controls previously defined using the Risk Control Entry form 1430. In this instance, as shown in FIG. 14D, the user has selected risk control with a tag of “RC003,” as shown in field 1452. The characterization of this risk control is as follows:

| | |
|---|---|
| Tag | RC003 |
| Description | Devices performs 2AM auto test of Therapy |
| | Control and Therapy Delivery systems using . . . |

After applying this one risk control (RC Tag 003), risk assessment fields 1453 show that the risk of hazard ID 2 occurring has been lessened slightly:

| | |
|---|---|
| Risk Control Factor | 10 (risk control is 90% effective) |
| Post RC Severity | is critical, even after applying the risk control |
| Post RC Likelihood | 1 in every 1000 uses, which is “probable” |
| | according to the risk matrix mappings |
| Post RC Risk Class | Significant (1) |

Thus, after applying this risk control (considered by itself), the risk has been move to a risk classification that is only one classification better.

However, the residual risk assessment, which takes into account all of the risk controls applied (see field 1454), shows that the risk of death (caused by the isolation relay stuck in a closed position) is reduced:

| | |
|---|---|
| Severity | Critical |
| Likelihood | 1 in every 500,000 essential uses, which makes |
| | the risk now “improbable” according to the risk |
| | matrix mappings |
| Risk Classification | Insignificant (4), which although still in the |
| | “questionable” category, is much closer to broadly |
| | acceptable |

Therefore, by applying careful risk controls to reduce the chance that the isolation relay will get “stuck,” the company has made risk management decisions that may have reduced the risk to as low as reasonably practicable standards.

FIG. 14E is a display screen showing how a user can link the hazard scenario described by FIG. 14A to a particular sub-assembly of the part that is causing the hazard. Specifically, the user can select the subassembly/accessory button 1461 and further select the specific subassembly from dropdown list 1462. In this case, the user selects the Power Supply as causing the hazard.

As described in step 103 in FIG. 1, the next step in evaluating the hazard scenario described in FIG. 14A is to examine the inherent failures caused by the design of the product and to link them to appropriate hazard scenarios. FIGS. 15A-15B are example screen displays illustrating data entry for inherent failures relating to the example hazard scenario ID 2 characterized in FIGS. 14A-14E. This allows the personnel responsible for managing design risks to do so in view of the hazards the particular part or subassembly effects. In the Design FMECA Data Entry module 1500 shown in FIG. 15A, the user first selects the subassembly/subcomponent of interest in field 1501. In this case, it is the power supply. A part number, if already defined, is selected infield 1502. If the part number has not yet been entered, it can be defined in filed 1511 in FIG. 15B. Many of the rest of the descriptive fields are automatically populated based upon the previous descriptions from the administration and setup functions. Importantly, the user can select a failure mode (here “stuck high”) in field 1503, and a failure rate in field 1507 (here 3.7 per million hours). In addition, the user links this failed subassembly description to a hazard scenario in field 1506 (here Hazard ID 2). This causes the RMDFS to automatically compute the likelihood, severity, and risk classification from the risk matrix that is attributable to this part.

In particular, the contribution of the Power Supply inherent failures to the hazard scenario ID 2 is:

| | |
|---|---|
| Likelihood | 1 in 270,000 uses, which corresponds to |
| | “improbable” according to risk matrix mappings, |
| | which is .037% of the total for hazard scenario 2, |
| | [percent contribution = (100 * ((1/270,000 users)/ |
| | (1/100 uses))] |
| Severity | Critical (since hazard ID 2 is associated with a |
| | death) |
| Risk Classification | Insignificant (4) |

Thus, the contribution of inherent failures in the design to the isolation relay being stuck “high” is pretty negligible.

Next, failures induced by the manufacturing process to cause hazard scenario ID 2 are examined in FIGS. 16A-16C. Here, one of the processes being examined in the Installation of the AC Power Connector Assembly (see field 1601), which relates to the Power Assembly subassembly inherent failures examined in FIG. 15A. Process failure risk management may be identified and characterized in the Process FMECA Data Entry module 1600. In an example embodiment, the Process FMECA Data Entry module 1600 includes a PFMECA form 1610, a Processes form 1620, and a Risk Control form 1630.

In this case, in form 1610, the user indicates that it may be possible for the connector to not be fully inserted, as caused by “operator carelessness” (field 1602) which results in an installation error. The failure is indicated as “random” (field 1603), with a likelihood of failure of 1 in 1000 uses (field 1608). This failure is linked to Hazard ID 2 in field 1605. As a result, the RMDFS automatically computes the severity and risk classification from the risk matrix that is attributable to this process failure and indicates this assessment in field 1609:

| | |
|---|---|
| Severity | Critical (since Hazard ID 2 is associated with |
| | death) |
| Likelihood | 1 in 1000 uses is indicated as probable according |
| | to the risk matrix mappings |
| Risk Classification | Significant (1) |

However, various risk controls may be identified to reduce the likelihood of this process failure. One, “visual inspection of assembly” is identified in field 1603. The effects of this risk control are described in detail in field 1606 and detail regarding the process and application of the risk control is described in field 1607. Once the risk control is applied, the residual risk of Hazard ID 2 occurring, as measured by the contribution of this process failure is now:

| | |
|---|---|
| Severity | Critical (since Hazard ID 2 is associated with |
| | death) |
| Likelihood | reduced to 1 in 20000 which is “remote” according |
| | to the risk matrix mappings, which is .05% of the |
| | total for hazard scenario 2. |
| Risk Classification | Significant (3) |

Thus, careful application of risk controls to induced (process related) failures has reduced the risk of death caused by the stuck relay switch in the closed position substantially.

FIG. 16B illustrates another process failure applied to Hazard ID 2 hazard scenario. This time the “collect PCBA from Provisioning Bin” process (field 1641) is being identified as a source for possible failures which could cause hazard ID 2. After the user enters data in a similar manner to that described with reference to FIG. 16A, and links the possible process failure to Hazard ID 2, then the RMDFS automatically computes the residual risk assessment shown in field 1644.

FIG. 16C illustrates data entry for one of the risk controls applied to the process failure described in FIG. 16A. In particular, the “perform visual inspection of assembly (field 1603), which is labeled with a risk control tag of PRC0001 in FIG. 16A, is shown in field 1631. This risk control has an effectiveness factor of 20, which is 95% effective. The risk caused by this risk control failing is described in the risk control risk assessment area 1632 and is:

| | |
|---|---|
| Harm | trivial injury or illness (harm field 1633) |
| Likelihood | 1 in every 100 uses (field 1435) which is “frequent” |
| | according to the risk matrix mappings |
| Severity | Negligible |
| Risk Classification | Insignificant (4) |

Because this risk control was directed to control the process failure caused by incorrect installation of the AC Power Connector (FIG. 16A), and because that process failure was associated with the hazard scenario of Hazard ID 2, this risk control is considered to control risk for the hazard scenario described by Hazard ID 2 (see fields 1637 and 1638).

Accordingly, once the hazard scenario has been identified and characterized, and once the various inherent (design) and induced (process) failures have been identified and characterized, the RMDFS is ready to assist the company in integrating and responding to data from observed and/or recorded experiences with use of a product or service so that corrective action may be instituted (steps 105-107 in FIG. 1).

FIGS. 17A-17B are example screen displays illustrating data entry for identifying and characterizing demonstrated risk experience as a result of harm from using a product that is linked to the example hazard scenario defined in FIGS. 14A-14E. Specifically, a Medical Device Report (MDR) has been entered into the DPRA Data Entry module 1700. The report is entered in field 1702. The number of “adverse events” is designated as “0” because no deaths occurred. However, 1 adverse event is indicated in field 1701. In fields 1703, the event is characterized as a random event from a device, while used for patient care, in a hospital. The problem found is described in field 1706 as the defibrillator discharging transferring energy without operator control—much like the hazard scenario defined back in FIG. 14A. Indeed, the person reporting the MDR to the RMDFS indicates in fields 1704 that the hazard correlates to the details of “therapy delivered unexpectedly” and associates the problem with hazard scenario ID 2 in field 1708.

Next, the operator (user) selects either the view risk assessment button 1712 or the update risk assessment button 1713 to view or adjust the number of actual uses that correspond to this report, so that the risk assessment summary in area 1710 can be updated to reflect real life manifested experience. For example, when the user selects the view risk assessment button 1712, the display screen of FIG. 17B is displayed. In fields 1720, the user enters the actual number of distributed units and their average use time. The user is shown data that corresponds to the previously linked hazard scenario (field 1721). The user then selects the recalculated button 1725 to cause the module to update the risk assessment summary 1710 in FIG. 17A.

The risk assessment summary 1710 contains two parts: 1) a comparison of actual risk, computed based upon the actual use data and recorded experience, relative to the estimated risk computed from the hazard scenario and associated risk controls and 2) a prediction of the number of adverse harms to be expected in the next year. In one embodiment, in the comparison of actual risk to estimated risk, the actual risk is computed using the use data entered in FIG. 17B in conjunction with the algorithms described below (algebra or Bayesian methods) to determine the likelihood that the risk will occur given the actual use data. The severity is determined from the associated hazard scenario (field 1708). In the case demonstrated in FIG. 17A, the likelihood is computed using a Bayes formula, because there has been no adverse harms. It is computed to be 1 in every 71,000 uses, which is within the 1:100,000 uses originally defined in the Sys Admin module as “remote.” With a severity of “critical” (Hazard ID 2 is death), this combination yields a risk classification of “significant (3),” which is worse than the estimated risk classification of “insignificant (4)” shown in the risk file that was set up in the Hazard Scenario Data Entry module for Hazard ID 2. (See, for example, FIG. 14D, which shows a likelihood of 1:500,000 and a risk classification of Insignificant (4), after applying the risk controls.) Accordingly, the actual risk indications given real live experience are worse than what is desired by the company, and additional corrective action should be planned. Note that the “worse” comparison result is indicated in yellow. Other indicators can be used such as highlighting, graphics, symbols, textures, and other techniques for presenting emphasis.

Field 1715 shows the result of estimating the number of adverse harms expected in the next year based upon the actual experience data available in the system. In this case, 1 adverse harm is expected.

As mentioned above, example embodiments of an RMDFS determine the likelihood metric used in field 1711 for comparing actual risk to estimated risk using two different models. If there has been any adverse event, the RMDFS uses an algebraic formula. Otherwise, the RMDFS employs a Bayesian model to predict the number of adverse incidents in the next year. The choice to use a different analysis technique when adverse harm is involved is based on the following observations:
1. People are much less tolerant of risk when “death or serious injury” or adverse harm has been manifested than when these levels of harm have not been manifested. Hence the RMDFS solution focuses attention on adverse harm and the prediction in field 1715 supports this focus.
2. Regulations and laws in some industries apply different requirements when adverse harm has been manifested.
3. Manufacturers or providers need to be able to predict the rate of adverse harm prior to manifesting adverse harm to be able to be proactive.

More information on application of Bayes technique may be found in Lipson and Sheth, “Statistical Design and Analysis of Engineering Experiments, New York, McGraw-Hill, 1973,” which is incorporated herein by reference. This metric is the standard metric used throughout ALL risk management activities and modules in the example RMDFS. It is presented as a ratio, or probability of failure, reflecting the number of product uses or service instances wherein one event is manifested. Regardless of the technique, experience data is the same and includes the number of times the product has been used or the service has been provided.

Likelihood has two components: the number of uses (how many times the service is provided that could result in the harm, which is “N” below), and the ratio of 1 in “x” number of uses, which is a probability that x number of uses will result in a harm. In the example embodiment, likelihood is thus computed as follows:

“0”Adverse Harm Manifested—Bayes' Formula

likelihood of success=R=(1−Confidence Level)^{(1/N+1)}

likelihood of failure=F=1−R
Confidence Level is defined as part of System Admin module within the Management/Company form. Confidence Level may be defined from 50% to 100%. 50% confidence means that 50% of the time the estimate will be low and 50% of the time it will be high.
N=Number of times the product has been used or the service has been provided. This variable establishes how much experience you have, and is the essential factor that defines how wide your confidence bounds are (i.e. establishes the limits of how far off you will be with your final estimate). To illustrate how N is derived we will use a product.

N=number of essential uses wherein adverse harm may be manifested=Product Population*Average Time in Service*Use Rate per unit time.
Product Population is defined by the user in the Risk Assessment popup window (see FIG. 17B).
Average Time in Service in months is defined by the user in the Risk Assessment popup window (see FIG. 17B).
Use Rate per unit time is defined by the user in the System Admin Management/Product form when characterizing the product. Use rate is defined by a number of uses and a period of time specified by the user.

“1” or more Adverse Harm Events Manifested—Algebra

F=Failure=1−R

Products

R=1−(Number of manifested adverse consequences/Number of product uses)=1−(Na/Nᵤ)

Services

R=1−(Number of manifested adverse consequences/Number of service instances)=1−(Na/Nₛ)
where,
   Na=Number of manifested adverse events
   Nᵤ=Number of product uses
   Nₛ=Number of service instances
Na=Number of manifested adverse consequences. This number is taken directly from the sum of ALL problem reports where in the user has identified that adverse harm has been manifested. This is entered in the Problem Report portion of the DPRA Record when the problem is first characterized.
Nᵤ & Nₛ=Number of times the product has been used or the service has been provided. This variable establishes how much experience you have, and is the essential factor that defines how wide your confidence bounds are (i.e. establishes the limits of how far off you will be with your final estimate). To illustrate how Nᵤ is derived we will use a product.

Nᵤ=number of essential uses where in adverse harm may be manifested=Product Population*Average Time in Service*Use Rate per unit time
Product Population is defined by the user in the Risk Assessment popup window (see FIG. 17B).
Average Time in Service in months is defined by the user in the Risk Assessment popup window (see FIG. 17B).
Use Rate per unit time is defined by the user in the System Admin module, Management/Product form when characterizing the product. Use rate is defined by a number of uses and a period of time specified by the user.
Confidence level for this algebraic technique is 50% since it is the best estimate of what the data is communicating and no factors have been applied to adjust confidence.

Note that in other embodiments of the RMDFS, the computation of the likelihood metric for use in comparing actual risk to estimated risk may be performed using other methods. For example, any method for translating the number of distributions and the average use time in months (fields 1720 in FIG. 17B) to number of uses, which is the scale used to determine the likelihood ratios set up in the system admin module, (see, e.g., FIG. 5B) can be used. For example, if an average of uses per month is known, or can be estimated or assumed, then the likelihood ratio is 1: (# distributions*average use time in months*average no uses per month). Alternatively, a look up table to map number of distributions and average use time in months to a likelihood ratio could also be used. This computed likelihood is then used, along with severity, to look up the corresponding risk classification from the risk matrix.

Note as well that determination of the likelihood metric for use in comparing actual risk to estimated risk and in the prediction of number of adverse events in the next year can apply as well to “single use” products and services as well as to multi use products and services. In this case, the probability of failure is calculated the same as for other products (using a Bayes algorithm or algebra), however the number of uses (N) is calculated differently. In the single use (or limited use) case, the number of products consumed is entered in the Risk Assessment window in FIG. 17B along with the number of users for each product, which is typically 1 for a single use product. (For a “kit” type of product, the number of user for each product may be >1, e.g., a blood testing kit, which is a single use product for multiple users.) Accordingly, N is determined as follows:

N=Number of Products Consumed*Average Patients Served per Product

Thus, any type of product use model can be accommodated using similar adjustments to computation of the number of essential uses “N.”

Field 1715 displays the number of people who may be adversely harmed over the next year. It is a predictive metric that is intended to facilitate corrective and preventative actions in a timelier manner. The number of people harm is derived the same way whether harm has been manifested or has not been manifested.

In an example embodiment of the RMDFS, one formula is as follows:

Product

X=N(uses)*P(adverse harm per use)

Service

X=N(service instances)*P(adverse harm per service instance)
Note: The number of patients harmed is a function of the number of patients served and the number of service instances per patient. The RMDFS assumes that if one service instance adversely harms a patient, then the service provider will not try another service instance on that same patient.
X=Number of people predicted to be adversely harmed
N (uses)=Number of products in service*N (uses per product in 12 months)
N (service instances)=Optional
   N (service instances)=N (patients expected the next 12 months)*N (service instances per patient)
   N (service instances)=N (service instances expected the next 12 months)
N (uses per product in 12 months) is estimated from data defined in System Admin module, Management/Product forms. Here in the user characterizes the product by how often it is used to provide essential functionality that can cause adverse harm. This factor includes two key variables, the number of times this function is provided, and the timeframe over then this number of essential uses is provided. For example, a product may be used:
   1 time every day
   3 times each week
   2 times each month
   0.034 times each 8 hour shift

Certain heuristics are incorporated to ensure that the RMDFS facilitates proper decision making when the predictive adverse event metric shown in FIG. 17A is arguably out of synch with the risk classification derived from the risk matrix. For example, it is possible to end up with a situation where many people are predicted to be harmed, but the risk classification metric otherwise would indicate that the risk is “broadly acceptable.” It is also possible to end up with a situation where no one is identified as predicted to be harmed in the next year, but the risk classification indicates that the risk is “broadly unacceptable.”

To mitigate these situations, the following rules are applied to the computation of the metrics shown in fields 1715 and 1711:
The predicted number of people adversely harmed is rounded to three significant decimals.
The predicted number of people adversely harmed is ALWAYS “0” if the severity associated with the hazard scenario describes a level that does not create or allow death or serious injury.
The predicted number of people adversely harmed is rounded to whole numbers only on the DPRA Data Entry form. The color (or other comparative indication) of this value is dependent on the actual rounded number applying three significant decimals (see the first item).
The predicted number of people adversely harmed is actually computed for a 2 year period, consistent with Medical Device Reporting regulations imposed by the Food and Drug Administration. So, a “0” number of people adversely harmed in the next year could mean either “0” for a period of the next 2 years, or “0” in the next year, but “1” in the year after that. The system differentiates between these two cases by indicating each situation differently. When the actual prediction is less than 0.25 in the next year (hence under 0.50 in the next 2 years), the predicted number of people adversely harmed is “0” and the color (or other comparative indication) of this value is that of Broadly Acceptable. The shading of this metric reflects Broadly Acceptable risk.
When the actual prediction is greater than or equal to 0.25 and less than 0.50 in the next year (hence greater than or equal to 0.50 and less than 1.0 in the next 2 years), the predicted number of people adversely harmed is “0” and the color (or other comparative indication) of this value is that of Acceptable. The shading of this metric reflects Acceptable risk.
When the predicted number of people adversely harmed is one “1” or more, the risk metric Risk Classification, or likelihood of harm during each use, supersedes this metric to be consistent with ALL other risk files. Hence, even if 15 people are predicted to be adversely harmed in the next year, and the likelihood or probability of harm is one in 158,000, the risk classification associated with this statistic from the risk matrix will be used to indicate the absolute prediction of harm. So, for example, if the risk matrix defines one “1” in 100,000 or less as Broadly Acceptable, then the color of the prediction of 15 adverse harms in the next year will be shaded to classify this number of adverse harms as broadly acceptable.

FIG. 18 is an example screen display of a report generated for a demonstrated risk experience using an example Risk Management Decision Facilitator System. This report is generated using a “reports” interface. In this case the user has selected to generate a report for the CardioMaster product, marked “Confidential,” after entering the actual experience data shown in FIGS. 17A-17B. The report 1700 contains a risk assessment 1701, description of the corresponding hazard scenario 1702, an analysis of risk 1703, and a problem report history 1704. As can be seen from the problem report history 1704, there have been 4 adverse events (1705) and 5 non adverse events (1706). Accordingly, as explained above, the risk assessment is performed using an algebraic formula to determine likelihood (see fields 1712 and 1714). The number of adverse events in the next year is shown in field 1710.

As mentioned with respect to FIG. 3, the Risk Management Decision Facilitator System also assists a company to determine the number of tests it needs to conduct for validation and verification. FIG. 19 is an example screen display of validation and verification support provided by an example Risk Management Decision Facilitator System. The V&V Data Entry module 1900 contains information to assist staff in completing testing to validate and verify the risk management decisions (e.g., the risk controls) set up earlier. The minimum sample size with no failures (field 1910) is computed based upon the desired reliability and confidence numbers expressed in the Management/Company Info form (see FIG. 3). The related hazard scenario is shown in field 1901. The V&V Data may be used, for example, to exhibit compliance with industry standards.

One additional benefit of the Risk Management Decision Facilitator System is its ability to ensure that only approved data that is carried electronically through the modules is allowed to cause the generation of reports or other output. That is, the data records are the “masters” and must be kept in a non-compromised state. Since the modules in an example RMDFS are used hierarchically, it is possible to ensure that only approved data is output.

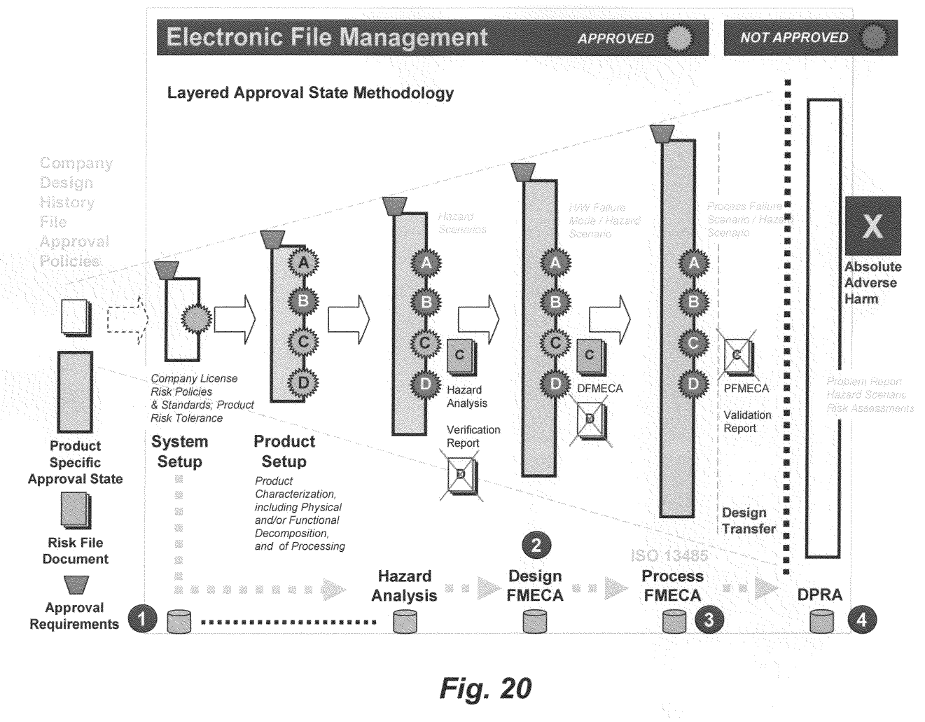

FIG. 20 is an example block diagram of electronic file management techniques employed by an example Risk Management Decision Facilitator System. In FIG. 20, the various modules are shown hierarchically with data passing between them. Since it is possible for data in a later invoked module to become unapproved, it is possible for the RMDFS to reject a user's ability to produce a report down the line. In the example shown, the product “C” data is in an approved state, until it is accessed by the PFMECA module, and thus the PFMECA analysis and validation report on product “C” data triggered from the PFMECA module will be prohibited. Earlier reports involving product “C” data (and any other approved data) that are invoked from modules prior to the PFMECA module in the hierarchy will still succeed, since the product “C” data is in an approved state prior to that point. This ability to ensure data integrity allows the RMDFS to comply with government electronic signature standards (e.g., 21 CFR Part 11) based upon the data alone acting as “master” records.

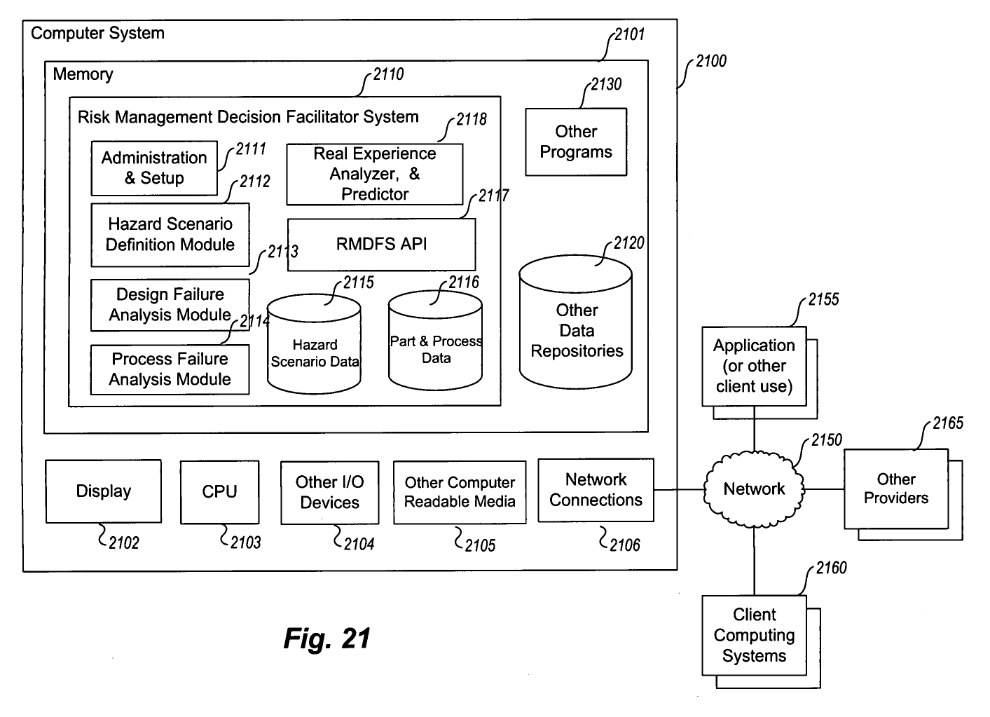

FIG. 21 is an example block-diagram of an example computing system that may be used to practice embodiments of a Risk Management Decision Facilitator System described herein. Note that a general purpose or a special purpose computing system may be used to implement a RMDFS. Further, the RMDFS may be implemented in software, hardware, firmware, or in some combination to achieve the capabilities described herein.

The computing system 2100 may comprise one or more server and/or client computing systems and may span distributed locations. In addition, each block shown may represent one or more such blocks as appropriate to a specific embodiment or may be combined with other blocks. Moreover, the various blocks of the Risk Management Decision Facilitator System 2110 may physically reside on one or more machines, which use standard (e.g., TCP/IP) or proprietary interprocess communication mechanisms to communicate with each other.

In the embodiment shown, computer system 2100 comprises a computer memory (“memory”) 2101, a display 2102, one or more Central Processing Units (“CPU”) 2103, Input/Output devices 2104 (e.g., keyboard, mouse, CRT or LCD display, etc.), other computer-readable media 2105, and one or more network connections 2106. The RMDFS 2110 is shown residing in memory 2101. In other embodiments, some portion of the contents, some of, or all of the components of the RMDFS 2110 may be stored on and/or transmitted over the other computer-readable media 2105. The components of the Risk Management Decision Facilitator System 2110 preferably execute on one or more CPUs 2103 and manage the facilitation of risk management decisions and use of the risk assessment modules, as described herein. Other code or programs 2130 and potentially other data repositories, such as data repository 2120, also reside in the memory 2110, and preferably execute on one or more CPUs 2103. Of note, one or more of the components in FIG. 21 may not be present in any specific implementation. For example, some embodiments embedded in other software many not be attached to a network.

In a typical embodiment, the RMDRS 2110 includes one or more administration and setup modules 2111, one or more hazard scenario definition modules 2112, one or more design failure analysis modules, one or more process failure analysis modules 2114, and one or more real experience analyzer and predictor modules 2118. In at least some embodiments, the real experience analyzer and predictor 2118 is provided external to the RMDFS and is available, potentially, over one or more networks 2150. Other and/or different modules may be implemented. In addition, the RMDFS may interact via a network 2150 with application or client code 2155 that e.g. uses results computed by the RMDFS 2110, one or more client computing systems 2160, and/or one or more third-party information provider systems 2165, such as purveyors of information used in part and process data repository 2116. Also, of note, the data repository 2116 may be provided external to the RMDFS as well, for example in a knowledge base accessible over one or more networks 2150.

In an example embodiment, components/modules of the RMDFS 2110 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an RMDFS implementation.

In addition, programming interfaces to the data stored as part of the RMDFS 2110 (e.g., in the data repositories 2116 and 2117 or the risk assessments) can be available by standard means such as through C, C++, C#, and Java APIs; libraries for accessing files, databases, or other data repositories; through scripting languages such as XML; or through Web servers, FTP servers, or other types of servers providing access to stored data. The data repositories 2115 and 2116 may be implemented as one or more database systems, file systems, or any other method known in the art for storing such information, or any combination of the above, including implementation using distributed computing techniques.

Also the example RMDFS 2110 may be implemented in a distributed environment comprising multiple, even heterogeneous, computer systems and networks. For example, in one embodiment, the hazard definition module 2112, the process failure analysis module 2114, and the parts & process data repository 2116 are all located in physically different computer systems. In another embodiment, various modules of the RMDFS 2110 are hosted each on a separate server machine and may be remotely located from the tables which are stored in the data repositories 2115 and 2116. Also, one or more of the modules may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an RMDFS.

Furthermore, in some embodiments, some or all of the components of the RMDFS may be implemented or provided in other manners, such as at least partially in firmware and/or hardware, including, but not limited to one ore more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be transmitted as contents of generated data signals (e.g., by being encoded as part of a carrier wave or otherwise included as part of an analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet are incorporated herein by reference, in their entirety.

From the foregoing it will be appreciated that, although specific embodiments have been described herein for purposes of illustration, various modifications may be made without deviating from the spirit and scope of the present disclosure. For example, the methods and systems for performing risk management decision making discussed herein are applicable to other architectures other than a web-based architecture. Also, the methods and systems discussed herein are applicable to differing protocols, communication media (optical, wireless, cable, etc.) and devices (such as wireless handsets, electronic organizers, personal digital assistants, portable email machines, game machines, pagers, navigation devices such as GPS receivers, etc.).

1. A method in a computing system for facilitating risk management decision making for a device or product, comprising:
receiving an indication of a desired risk matrix to be used to identify risks associated with the device or product;
generating and storing a risk matrix in accordance with the indicated desired risk matrix;
receiving indications of a plurality of hazard scenarios for a device or product, each hazard scenario indicating at least an associated hazard event, an associated harm, and an indication of likelihood of occurrence of the associated harm;
for each indicated hazard scenario, automatically generating an associated risk assessment by,
determining, based upon the stored risk matrix, a severity level corresponding to the indicated associated harm; and
determining an associated risk classification based upon the determined severity level, the indicated likelihood of occurrence of the associated harm, and the stored risk matrix, the risk classification describing the level of risk of the indicated associated harm;
receiving at least one specification of a failure mode analysis of a part or process, the at least one specification indicating a measure that is determinative of a likelihood of occurrence of an associated failure and indicating an associated hazard scenario;
automatically providing a corresponding risk assessment by correlating, based upon the indicated hazard scenario associated with the at least one specification of the failure mode analysis of the part or process, the failure mode analysis to an associated severity level corresponding to the associated failure and to an associated risk classification describing the level of risk of the associated failure; and
presenting on an output device associated with the computing system the failure mode analysis of the part or process and the corresponding risk assessment, including the associated severity level and associated risk classification, to enable analysis of the associated failure of the part or process using an assessment of risk that is automatically consistent with the associated hazard scenario.

2. The method of claim 1, further comprising:
presenting on an output device associated with the computing system the associated hazard scenario including the automatically generated associated risk assessment.

3. The method of claim 1 wherein the at least one specification of a failure mode analysis of a part or process is a design failure mode analysis.

4. The method of claim 1 wherein the at least one specification of a failure mode analysis of a part or process is a process failure mode analysis.

5. The method of claim 1 wherein the failure mode analysis provides an estimated risk assessment.

6. The method of claim 1, wherein the receiving the indication of the desired risk matrix further comprises:
receiving an indication of a desired risk matrix by receiving a specification of a risk matrix size.

7. The method of claim 1 wherein the generating and storing the risk matrix for the device or product in accordance with the indicated desired risk matrix further comprises:
generating and storing the risk matrix for the device or product in accordance with the indicated desired risk matrix, the generated risk matrix indicating a plurality of terms that represent different levels of severity of harm, indicating a plurality of terms that represent different likelihoods of occurrence of harm, and indicating a risk class associated with each severity level term and likelihood of occurrence term pair, each risk class indicative of a classification of risk.

8. The method of claim 1 wherein each risk classification indicates that a risk is one of a broadly unacceptable risk, a questionably acceptable risk, or a broadly acceptable risk.

9. The method of claim 1 wherein at least one of the indicated hazard scenarios includes an indication of at least one cause of the hazard, and a description of one or more risk controls that may be used to reduce the severity and/or likelihood of occurrence of the hazard event associated with the at least one hazard scenario.

10. The method of claim 1, further comprising:
receiving an indication of an observed or recorded problem, including an associated hazard scenario and indication of actual use of the device or product; and
automatically generating a problem risk assessment, by
determining a level of severity based upon the hazard scenario associated with the problem;
determining a likelihood of occurrence based upon the stored risk matrix and the indication of actual use;
determining a risk classification that corresponds to the problem based upon the determined level of severity and the determined likelihood of occurrence and the stored risk matrix; and
indicating a comparative risk assessment based upon a comparison of the determined risk classification that corresponds to the problem to the risk classification associated with the indicated hazard scenario and providing an indication of the comparison.

11. The method of claim 10 wherein the comparative risk assessment is indicated by indicated whether the determined risk classification that corresponds to the problem is better, the same as, or worse than the risk classification associated with the indicated hazard scenario.

12. The method of claim 10 wherein the comparative risk assessment is indicated using at least one of color, patterns, shapes, or textures.

13. The method of claim 10, further comprising receiving an indication of a corrective modification to a hazard scenario or a failure mode analysis of a part or process based at least in part upon the indicated comparative risk assessment.

14. The method of claim 10, further comprising indicating an estimated number of adverse harms expected over a period of time based in part upon the received indication of the problem.

15. The method of claim 14 wherein the indicating the estimated number of adverse harms further includes computing the estimated number of adverse harms using Bayesian statistics.

16. The method of claim 10, further comprising presenting the indicated comparative risk assessment on a display device of the computing system.

17. A computer-readable storage medium containing content that, when executed, controls a computer processor to provide analyses to facilitate risk management decision making, by performing a method comprising:
receiving an indication of a desired risk matrix to be used to identify risks associated with the device or product;
generating and storing a risk matrix in accordance with the indicated desired risk matrix;
receiving indications of a plurality of hazard scenarios for a device or product, each hazard scenario indicating at least an associated hazard event, an associated harm, and an indication of likelihood of occurrence of the associated harm;
for each indicated hazard scenario, automatically generating an associated risk assessment by,
determining, based upon the stored risk matrix, a severity level corresponding to the indicated associated harm; and
determining an associated risk classification based upon the determined severity level, the indicated likelihood of occurrence of the associated harm, and the stored risk matrix, the risk classification describing the level of risk of the indicated associated harm;
receiving at least one specification of a failure mode analysis of a part or process, the at least one specification indicating a measure that is determinative of a likelihood of occurrence of an associated failure and indicating an associated hazard scenario;
automatically providing a corresponding risk assessment by correlating, based upon the indicated hazard scenario associated with the at least one specification of the failure mode analysis of the part or process, the failure mode analysis to an associated severity level corresponding to the associated failure and to an associated risk classification describing the level of risk of the associated failure; and
presenting on an output device associated with the computing system the failure mode analysis of the part or process and the corresponding risk assessment, including the associated severity level and associated risk classification, to enable analysis of the associated failure of the part or process using an assessment of risk that is automatically consistent with the associated hazard scenario.

18. The computer-readable storage medium of claim 17 wherein the storage medium is a computer memory and the contents are instructions stored in the memory.

19. The computer-readable storage medium of claim 17 wherein the storage medium is a computing transmission medium and the contents are transmitted data signals encoding instructions and/or data structures for controlling the computer processor to output analyses to facilitate risk management decision making.

20. A computing system, comprising:
a memory;
a configuration module, stored in the memory, configured, when executed, to generate a risk matrix, the risk matrix having a plurality of terms that represent different levels of severity of harm, a plurality of terms that represent different likelihoods of occurrence of harm, and a risk class associated with each severity level term and likelihood of occurrence term pair, each risk class indicative of a classification of risk;
a hazard scenario module, stored in the memory, and configured, when executed to receive a plurality of characteristics associated with a hazard scenario and to determine a corresponding risk class for the hazard scenario based in part on the plurality of characteristics and the risk matrix; and
a failure mode analysis module, stored in the memory, and configured, when executed, to receive a plurality of characteristics associated with potential failure of a part or process, the characteristics including an associated hazard scenario, and to automatically determine a risk assessment for the potential failure of the part or process based upon the associated hazard scenario to enable analysis of the potential failure using the same risk class as the associated hazard scenario.

21. The computing system of claim 20 wherein the failure mode analysis module is a design failure mode analysis module.

22. The computing system of claim 20 wherein the failure mode analysis module is a process failure mode analysis module.

23. The computing system of claim 20, further comprising:
a DPRA module, stored on the memory, configured, when executed to receive a characterization of an observed or recorded problem including a measurement of actual use and failure and an associated hazard scenario, and to output a comparative risk assessment that compares a risk class determined for the observed or recorded problem based upon the measurement of actual use and a severity level of the associated hazard scenario to the risk class associated with the associated hazard scenario.

24. The computing system of claim 20 wherein the generated risk matrix provides a maximum of six risk classes.

25. The computing system of claim 20 wherein the generated risk matrix provides risk classes that indicate broadly acceptable risk, broadly unacceptable risk, and questionable risk.

26. A method in a computing system for insuring compliance by preserving the integrity of master data, comprising:
providing a hierarchy of software modules, each module configured to operate on data that corresponds to one or more products or devices, the data configured to be in an unapproved state or an approved state, at least some of the modules receiving data from modules that are upstream;
receiving indication of an interaction with at least one of the software modules in a manner than causes the data operated on by the at least one of the software modules to transition the data operated on to an unapproved state and to forward the transitioned data as unapproved data; and
causing all software modules that are downstream in the hierarchy and that operate on unapproved data received from the at least one software module to refuse to generate documentation that involves the unapproved data and to continue to forward the unapproved data in an unapproved state, thereby insuring that only approved data is able to cause documentation to be produced.

27. The method of claim 26 wherein the documentation comprises a risk file document.

28. The method of claim 26 wherein compliance is insured with standards that specify master document requirements.

29. The method of claim 26 wherein the software module comprises modules that perform at least one of hazard analysis, design failure mode and criticality analysis, process failure mode and criticality analysis, or distributed process risk assessment.
